(19) United States
(12) Patent Application Publication
(10) Pub. No.: US 2025/0348599 A1
(43) Pub. Date: Nov. 13, 2025

(54) SYSTEMS AND METHODS FOR ENFORCING ENCODED POLICIES

(71) Applicant: DOVER MICROSYSTEMS, INC., Waltham, MA (US)

(72) Inventors: Andrew SUTHERLAND, Portland, OR (US); Steven MILBURN, Waltham, MA (US)

(73) Assignee: DOVER MICROSYSTEMS, INC., Waltham, MA (US)

(21) Appl. No.: 18/860,922

(22) PCT Filed: Apr. 27, 2023
(86) PCT No.: PCT/US2023/020132

§ 371 Date: Oct. 28, 2024

Related U.S. Application Data
(60) Provisional application No. 63/335,759, filed on Apr. 28, 2022.

(51) Int. Cl. G06F 21/60; G06F 21/78

(52) U.S. Cl. CPC G06F 21/602; G06F 21/78

(57) ABSTRACT

Systems and methods for enforcing one or more policies that are encoded as programmable hardware functions. In some embodiments, tag processing hardware may receive information relating to one or more instructions executed by a host system. The information may be used to construct an input pattern, which may be processed, in hardware, to obtain at least one indicator. The tag processing hardware may then determine whether the at least one indicator matches at least one parameter that is selected based on one or more policies being enforced by the tag processing hardware. In response to determining that the at least one indicator does not match the at least one parameter, the tag processing hardware may send a signal to the host system to indicate a violation of the one or more policies.

### RELATED APPLICATION

This application claims the benefit under 35 U.S.C. 119(e) of U.S. Provisional Application No. 63/335,759, entitled “SYSTEMS AND METHODS FOR ENCODING POLICIES,” filed on Apr. 28, 2022, which is incorporated herein by reference in its entirety.

### BACKGROUND

Computer security has become an increasingly urgent concern at all levels of society, from individuals to businesses to government institutions. For example, in 2015, security researchers identified a zero-day vulnerability that would have allowed an attacker to hack into a Jeep Cherokee's on-board computer system via the Internet and take control of the vehicle's dashboard functions, steering, brakes, and transmission. In 2017, the WannaCry ransomware attack was estimated to have affected more than 200,000 computers worldwide, causing at least hundreds of millions of dollars in economic losses. Notably, the attack crippled operations at several National Health Service hospitals in the UK. In the same year, a data breach at Equifax, a US consumer credit reporting agency, exposed personal data such as full names, social security numbers, birth dates, addresses, driver's license numbers, credit card numbers, etc. That attack is reported to have affected over 140 million consumers.

Security professionals are constantly playing catch-up with attackers. As soon as a vulnerability is reported, security professionals rush to patch the vulnerability. Individuals and organizations that fail to patch vulnerabilities in a timely manner (e.g., due to poor governance and/or lack of resources) become easy targets for attackers.

Some security software monitors activities on a computer and/or within a network, and looks for patterns that may be indicative of an attack. Such an approach does not prevent malicious code from being executed in the first place. Often, the damage has been done by the time any suspicious pattern emerges.

### SUMMARY

In accordance with some embodiments, a computer-implemented method is provided for enforcing one or more policies that are encoded as programmable hardware functions. The method may be performed by tag processing hardware, and may comprise acts of: receiving information relating to one or more instructions executed by a host system; using the information relating to the one or more instructions to construct an input pattern; processing, in hardware, the input pattern to obtain at least one indicator; determining whether the at least one indicator matches at least one parameter, wherein the at least one parameter is selected based on one or more policies being enforced by the tag processing hardware; and in response to determining that the at least one indicator does not match the at least one parameter, sending a signal to the host system to indicate a violation of the one or more policies.

In accordance with some embodiments, a computer-implemented method is provided for encoding one or more policies to be enforced. The method may comprise acts of: identifying one or more allowed input patterns for the one or more policies to be enforced; constructing, based on the one or more allowed input patterns, a plurality of constraints; and identifying one or more encode functions that satisfy the plurality of constraints, wherein each encode function maps metadata labels to bit strings.

In accordance with some embodiments, a system is provided, comprising processing hardware configured to perform any of the methods described herein. The processing hardware may include one or more processors programmed by executable instructions, one or more field-programmable gate arrays (FPGAs) programmed by bitstreams, and/or one or more logic circuits fabricated into semiconductors.

In accordance with some embodiments, at least one computer-readable medium is provided, having stored thereon any of the bitstreams described herein.

In accordance with some embodiments, at least one computer-readable medium is provided, having stored thereon at least one netlist for any of the bitstreams and/or fabricated logic described herein.

In accordance with some embodiments, at least one computer-readable medium is provided, having stored thereon at least one hardware description that, when synthesized, produces any of the netlists described herein.

In accordance with some embodiments, at least one computer-readable medium is provided, having stored thereon any of the executable instructions described herein.

### BRIEF DESCRIPTION OF DRAWINGS

FIG. 1 shows an illustrative hardware system 100 for enforcing policies, in accordance with some embodiments.

FIG. 2 shows an illustrative software system 200 for enforcing policies, in accordance with some embodiments.

FIG. 3 shows an illustrative finite state machine (FSM) 300, in accordance with some embodiments.

FIG. 4 shows an illustrative process 400 that may be used to identify input patterns, in accordance with some embodiments.

FIG. 5 shows an illustrative process 500 for resolving a metadata label into a binary representation, in accordance with some embodiments.

FIG. 6A shows an illustrative hardware block 600 implementing a policy check function, in accordance with some embodiments.

FIG. 6B shows an illustrative array 650 of bits, in accordance with some embodiments.

FIG. 7A shows an illustrative arrangement 700 of functions, in accordance with some embodiments.

FIG. 7B shows an illustrative conversion block 750, in accordance with some embodiments.

FIG. 8 shows an illustrative process 800 for selecting an encode function and a parameter, in accordance with some embodiments.

FIG. 9A shows an illustrative arrangement 900 of functions, in accordance with some embodiments.

FIG. 9B shows an illustrative output function block 910, in accordance with some embodiments.

FIG. 9C shows an illustrative array 920 of bits, in accordance with some embodiments.

FIG. 10A shows an illustrative arrangement 1000 of functions, in accordance with some embodiments.

FIG. 10B shows an illustrative conversion block 1010, in accordance with some embodiments.

FIG. 10C shows an illustrative conversion block 1020, in accordance with some embodiments.

FIG. 11 shows, schematically, an illustrative computer 1100 on which any aspect of the present disclosure may be implemented.

### DETAILED DESCRIPTION

This application may include subject matter related to that of International Patent Application No. PCT/US2019/016272, filed on Feb. 1, 2019, titled “SYSTEMS AND METHODS FOR POLICY LINKING AND/OR LOADING FOR SECURE INITIALIZATION,” bearing Attorney Docket No. D0821.70000WO00, which is hereby incorporated by reference in its entirety.

This application may include subject matter related to that of International Patent Application No. PCT/US2019/029880, filed on Apr. 30, 2019, titled “SYSTEMS AND METHODS FOR CHECKING SAFETY PROPERTIES,” bearing Attorney Docket No. D0821.70002WO00, which is hereby incorporated by reference in its entirety.

This application may include subject matter related to that of International Patent Application No. PCT/US2020/013678, filed on Jan. 15, 2020, titled “SYSTEMS AND METHODS FOR MATADATA CLASSIFICATION,” bearing Attorney Docket No. D0821.70013WO00, which is hereby incorporated by reference in its entirety.

This application may include subject matter related to that of International Application No. PCT/US2020/059057, filed on Nov. 5, 2020, entitled “SYSTEMS AND METHODS FOR IMPROVING EFFICIENCY OF METADATA PROCESSING,” bearing Attorney Docket No. D0821.70005WO00, which is hereby incorporated by reference in its entirety.

Many vulnerabilities exploited by attackers trace back to a computer architectural design where data and executable instructions are intermingled in a same memory. This intermingling allows an attacker to inject malicious code into a remote computer by disguising the malicious code as data. For instance, a program may allocate a buffer in a computer's memory to store data received via a network. If the program receives more data than the buffer can hold, but does not check the size of the received data prior to writing the data into the buffer, part of the received data would be written beyond the buffer's boundary, into adjacent memory. An attacker may exploit this behavior to inject malicious code into the adjacent memory. If the adjacent memory is allocated for executable code, the malicious code may eventually be executed by the computer.

Techniques have been proposed to make computer hardware more security aware. For instance, memory locations may be associated with metadata for use in enforcing security policies, and instructions may be checked for compliance with the security policies. For example, given an instruction to be executed, metadata associated with the instruction and/or metadata associated with one or more operands of the instruction may be checked to determine if the instruction is allowed. Additionally, or alternatively, appropriate metadata may be associated with an output of the instruction.

It should be appreciated that security policies are discussed above solely for purposes of illustration, as aspects of the present disclosure are not limited to enforcing any particular type of policy, or any policy at all. In some embodiments, one or more of the techniques described herein may be used to enforce one or more other types of policies (e.g., safety policies, privacy policies, etc.), in addition to, or instead of, security policies.

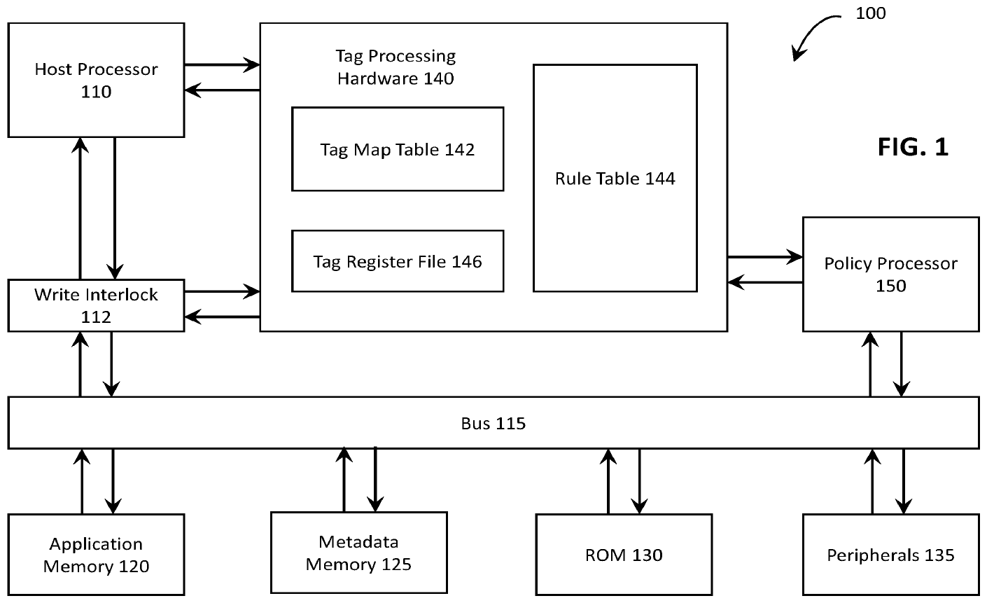

FIG. 1 shows an illustrative hardware system 100 for enforcing policies, in accordance with some embodiments. In this example, the system 100 includes a host processor 110, which may have any suitable instruction set architecture (ISA) such as a reduced instruction set computing (RISC) architecture or a complex instruction set computing (CISC) architecture. The host processor 110 may perform memory accesses via a write interlock 112. The write interlock 112 may be connected to a system bus 115 configured to transfer data between various components such as the write interlock 112, an application memory 120, a metadata memory 125, a read-only memory (ROM) 130, one or more peripherals 135, etc.

In some embodiments, data that is manipulated (e.g., modified, consumed, and/or produced) by the host processor 110 may be stored in the application memory 120. Such data may be referred to herein as “application data,” as distinguished from metadata used for enforcing policies. The latter may be stored in the metadata memory 125. It should be appreciated that application data may include data manipulated by an operating system (OS), instructions of the OS, data manipulated by one or more user applications, and/or instructions of the one or more user applications.

In some embodiments, the application memory 120 and the metadata memory 125 may be physically separate, and the host processor 110 may have no access to the metadata memory 125. In this manner, even if an attacker succeeds in injecting malicious code into the application memory 120 and causing the host processor 110 to execute the malicious code, the metadata memory 125 may not be affected. However, it should be appreciated that aspects of the present disclosure are not limited to storing application data and metadata on physically separate memories. Additionally, or alternatively, metadata may be stored in a same memory as application data, and a memory management component may be used that implements an appropriate protection scheme to prevent instructions executing on the host processor 110 from modifying the metadata. Additionally, or alternatively, metadata may be intermingled with application data in a same memory, and one or more policies may be used to protect the metadata.

In some embodiments, tag processing hardware 140 may be provided to ensure that instructions being executed by the host processor 110 comply with one or more policies. The tag processing hardware 140 may operate at hardware speed. For instance, the tag processing hardware 140 may be implemented using one or more FPGAs programed by bitstreams and/or one or more logic circuits fabricated into semiconductors, and therefore may be capable of checking instructions at a speed that is comparable to a speed at which the instructions are executed by the host processor 110.

In some embodiments, the tag processing hardware 140 may, on average, check one instruction for every N instructions executed by the host processor 110, where N may be 1, 2, 3, 4, 5, . . . , 10, . . . The number N may be chosen based on a proportion of instructions to be checked. As an example, if every instruction is to be checked, then N may be 1.

Additionally, or alternatively, an upperbound may be provided for a measure of divergence. As an example, the tag processing hardware 140 may include a queue for storing instructions to be checked. Such a queue may, at any given time, store at most M instructions, where M may be 10, . . . 50, . . . , 100, . . . , 500, . . . Thus, the tag processing hardware 140 may be at most M instructions behind the host processor 110 at any given time.

The tag processing hardware 140 may include any suitable component or combination of components. For instance, the tag processing hardware 140 may include a tag map table 142 that maps addresses in the application memory 120 to addresses in the metadata memory 125. For example, the tag map table 142 may map an address X in the application memory 120 to an address Y in the metadata memory 125. A value stored at the address Y may be referred to herein as a “metadata tag.”

In some embodiments, a value stored at the address Y may in turn be an address Z. Such indirection may be repeated any suitable number of times, and may eventually lead to a data structure in the metadata memory 125 for storing metadata. Such metadata, as well as any intermediate address (e.g., the address Z), may also be referred to herein as “metadata tags.”

It should be appreciated that aspects of the present disclosure are not limited to a tag map table that stores addresses in a metadata memory. In some embodiments, a tag map table entry itself may store metadata, so that the tag processing hardware 140 may be able to access the metadata without performing a memory operation. In some embodiments, a tag map table entry may store a selected bit pattern, where a first portion of the bit pattern may encode metadata, and a second portion of the bit pattern may encode an address in a metadata memory where further metadata may be stored. This may provide a desired balance between speed and expressivity. For instance, the tag processing hardware 140 may be able to check certain policies quickly, using only the metadata stored in the tag map table entry itself. For other policies with more complex rules, the tag processing hardware 140 may access the further metadata stored in the metadata memory 125.

Referring again to FIG. 1, by mapping application memory addresses to metadata memory addresses, the tag map table 142 may create an association between application data and metadata that describes the application data. In one example, metadata stored at the metadata memory address Y and thus associated with application data stored at the application memory address X may indicate that the application data may be readable, writable, and/or executable. In another example, metadata stored at the metadata memory address Y and thus associated with application data stored at the application memory address X may indicate a type of the application data (e.g., integer, pointer, 16-bit word, 32-bit word, etc.). Depending on a policy to be enforced, any suitable metadata relevant for the policy may be associated with a piece of application data.

In some embodiments, a metadata memory address Z may be stored at the metadata memory address Y. Metadata to be associated with the application data stored at the application memory address X may be stored at the metadata memory address Z, instead of (or in addition to) the metadata memory address Y. For instance, a binary representation of a metadata label RED may be stored at the metadata memory address Z. By storing the metadata memory address Z in the metadata memory address Y, the application data stored at the application memory address X may be tagged RED.

In this manner, the binary representation of the metadata label RED may be stored only once in the metadata memory 125. For instance, if application data stored at another application memory address X′ is also to be tagged RED, the tag map table 142 may map the application memory address X′ to a metadata memory address Y′ where the metadata memory address Z is also stored.

Moreover, in this manner, tag update may be simplified. For instance, if the application data stored at the application memory address X is to be tagged BLUE at a subsequent time, a metadata memory address Z′ may be written at the metadata memory address Y, to replace the metadata memory address Z, and a binary representation of the metadata label BLUE may be stored at the metadata memory address Z′.

Thus, the inventors have recognized and appreciated that a chain of metadata memory addresses of any suitable length N may be used for tagging, including N=0 (e.g., where a binary representation of a metadata label is stored at the metadata memory address Y itself).

The association between application data and metadata (also referred to herein as “tagging”) may be done at any suitable level of granularity, and/or variable granularity. For instance, tagging may be done on a word-by-word basis. Additionally, or alternatively, a region in memory may be mapped to a single metadata tag, so that all words in that region are associated with the same metadata. This may advantageously reduce a size of the tag map table 142 and/or the metadata memory 125. For example, a single metadata tag may be maintained for an entire address range, as opposed to maintaining multiple metadata tags corresponding, respectively, to different addresses in the address range.

In some embodiments, the tag processing hardware 140 may be configured to apply one or more rules to metadata associated with an instruction and/or metadata associated with one or more operands of the instruction to determine if the instruction is allowed. For instance, the host processor 110 may fetch and execute an instruction (e.g., a store instruction), and may queue a result of executing the instruction (e.g., a value to be stored) into the write interlock 112. Before the result is written back into the application memory 120, the host processor 110 may send, to the tag processing hardware 140, an instruction type (e.g., opcode), an address where the instruction is stored, one or more memory addresses referenced by the instruction, and/or one or more register identifiers. Such a register identifier may identify a register used by the host processor 110 in executing the instruction, such as a register for storing an operand or a result of the instruction.

In some embodiments, destructive load instructions may be queued in addition to, or instead of, store instructions. For instance, subsequent instructions attempting to access a target address of a destructive load instruction may be queued in a memory region that is not cached. If and when it is determined that the destructive load instruction is allowed, the queued instructions may be loaded for execution.

In some embodiments, a destructive load instruction may be executed, and data read from a target address may be captured in a buffer. If and when it is determined that the destructive load instruction is allowed, the data captured in the buffer may be discarded. If and when it is determined that the destructive load instruction should not be allowed, the data captured in the buffer may be restored to the target address. Additionally, or alternatively, a subsequent read may be serviced by the buffered data.

It should be appreciated that aspects of the present disclosure are not limited to performing metadata processing on instructions that a host processor has finished executing (e.g., instructions that have been retired by the host processor's execution pipeline). In some embodiments, metadata processing may be performed on instructions before, during, and/or after the host processor's execution pipeline. Thus, an instruction executed by the host processor may be an instruction that is queued for execution, being executed within a pipeline, or retired.

In some embodiments, given an address received from the host processor 110 (e.g., an address where an instruction is stored, or an address referenced by an instruction), the tag processing hardware 140 may use the tag map table 142 to identify a corresponding metadata tag. Additionally, or alternatively, for a register identifier received from the host processor 110, the tag processing hardware 140 may access a metadata tag from a tag register file 146 within the tag processing hardware 140.

In some embodiments, if an application memory address does not have a corresponding entry in the tag map table 142, the tag processing hardware 140 may send a query to a policy processor 150. The query may include the application memory address, and the policy processor 150 may return a metadata tag for that application memory address. Additionally, or alternatively, the policy processor 150 may create a new tag map entry for an address range including the application memory address. In this manner, the appropriate metadata tag may be made available, for future reference, in the tag map table 142 in association with the application memory address.

In some embodiments, the tag processing hardware 140 may send a query to the policy processor 150 to check if an instruction executed by the host processor 110 is allowed. The query may include one or more inputs, such as an instruction type (e.g., opcode) of the instruction, a metadata tag for a program counter, a metadata tag for an application memory address from which the instruction is fetched (e.g., a word in memory to which the program counter points), a metadata tag for a register in which an operand of the instruction is stored, and/or a metadata tag for an application memory address referenced by the instruction.

In one example, the instruction may be a load instruction, and an operand of the instruction may be an application memory address from which application data is to be loaded. The query may include, among other things, a metadata tag for a register in which the application memory address is stored, as well as a metadata tag for the application memory address itself. In another example, the instruction may be an arithmetic instruction, and there may be two operands. The query may include, among other things, a first metadata tag for a first register in which a first operand is stored, and a second metadata tag for a second register in which a second operand is stored.

It should also be appreciated that aspects of the present disclosure are not limited to performing metadata processing on a single instruction at a time. In some embodiments, multiple instructions in a host processor's ISA may be checked together as a bundle, for example, via a single query to the policy processor 150. Such a query may include more inputs to allow the policy processor 150 to check all of the instructions in the bundle. Similarly, a CISC instruction, which may correspond semantically to multiple operations, may be checked via a single query to the policy processor 150, where the query may include sufficient inputs to allow the policy processor 150 to check all of the constituent operations within the CISC instruction.

In some embodiments, the policy processor 150 may have loaded therein one or more policies. In response to a query from the tag processing hardware 140, the policy processor 150 may evaluate one or more of the policies to determine if an instruction giving rise to the query is allowed. For instance, the tag processing hardware 140 may send an interrupt signal to the policy processor 150, along with one or more inputs relating to the instruction (e.g., as described above). The policy processor 150 may store the inputs of the query in a working memory (e.g., in one or more queues) for immediate or deferred processing. For example, the policy processor 150 may prioritize processing of queries in some suitable manner (e.g., based on a priority flag associated with each query).

In some embodiments, the policy processor 150 may evaluate one or more policies on one or more inputs (e.g., one or more input metadata tags) to determine if an instruction is allowed. If the instruction is not allowed, the policy processor 150 may so notify the tag processing hardware 140. If the instruction is allowed, the policy processor 150 may compute one or more outputs (e.g., one or more output metadata tags) to be returned to the tag processing hardware 140. As one example, the instruction may be a store instruction, and the policy processor 150 may compute an output metadata tag for an application memory address to which application data is to be stored. As another example, the instruction may be an arithmetic instruction, and the policy processor 150 may compute an output metadata tag for a register for storing a result of executing the arithmetic instruction.

In some embodiments, the policy processor 150 may be programmed to perform one or more tasks in addition to, or instead of, those relating to evaluation of policies. For instance, the policy processor 150 may perform tasks relating to tag initialization, boot loading, application loading, memory management (e.g., garbage collection) for the metadata memory 125, logging, debugging support, and/or interrupt processing. One or more of these tasks may be performed in the background (e.g., between servicing queries from the tag processing hardware 140).

In some embodiments, the policy processor 150 may operate at software speed. For instance, the policy processor 150 may include a processor programmed by executable instructions to implement one or more of the functionalities described above. It may take hundreds, or even thousands, of processor cycles to execute one such instruction.

In some embodiments, the tag processing hardware 140 may include a rule table 144 for mapping one or more inputs to a decision and/or one or more outputs. For instance, a query into the rule table 144 may be similarly constructed as a query to the policy processor 150 to check if an instruction executed by the host processor 110 is allowed. If there is a match, the rule table 144 may output a decision as to whether to the instruction is allowed, and/or one or more output metadata tags (e.g., as described above in connection with the policy processor 150). Such a mapping in the rule table 144 may be created using a query response from the policy processor 150. However, that is not required, as in some embodiments, one or more mappings may be installed into the rule table 144 ahead of time.

In some embodiments, the rule table 144 may be used to provide a performance enhancement. For instance, before querying the policy processor 150 with one or more input metadata tags, the tag processing hardware 140 may first query the rule table 144 with the one or more input metadata tags. In case of a match, the tag processing hardware 140 may proceed with a decision and/or one or more output metadata tags from the rule table 144, without querying the policy processor 150. This may provide a significant speedup. If, on the other hand, there is no match, the tag processing hardware 140 may query the policy processor 150, and may install a response from the policy processor 150 into the rule table 144 for potential future use. Thus, the rule table 144 may function as a cache. However, it should be appreciated that aspects of the present disclosure are not limited to implementing the rule table 144 as a cache.

In some embodiments, the tag processing hardware 140 may form a hash key based on one or more input metadata tags, and may present the hash key to the rule table 144. If there is no match, the tag processing hardware 140 may send an interrupt signal to the policy processor 150. In response to the interrupt signal, the policy processor 150 may fetch metadata from one or more input registers (e.g., where the one or more input metadata tags are stored), process the fetched metadata, and write one or more results to one or more output registers. The policy processor 150 may then signal to the tag processing hardware 140 that the one or more results are available.

In some embodiments, if the tag processing hardware 140 determines that an instruction (e.g., a store instruction) is allowed (e.g., based on a match in the rule table 144, or no match in the rule table 144, followed by a response from the policy processor 150 indicating no policy violation has been found), the tag processing hardware 140 may indicate to the write interlock 112 that a result of executing the instruction (e.g., a value to be stored) may be written back to memory. Additionally, or alternatively, the tag processing hardware 140 may update the metadata memory 125, the tag map table 142, and/or the tag register file 146 with one or more output metadata tags (e.g., as received from the rule table 144 or the policy processor 150). As one example, for a store instruction, the metadata memory 125 may be updated based on an address translation by the tag map table 142. For instance, an application memory address referenced by the store instruction may be used to look up a metadata memory address from the tag map table 142, and metadata received from the rule table 144 or the policy processor 150 may be stored to the metadata memory 125 at the metadata memory address. As another example, where metadata to be updated is stored in an entry in the tag map table 142 (as opposed to being stored in the metadata memory 125), that entry in the tag map table 142 may be updated. As another example, for an arithmetic instruction, an entry in the tag register file 146 corresponding to a register used by the host processor 110 for storing a result of executing the arithmetic instruction may be updated with an appropriate metadata tag.

In some embodiments, if the tag processing hardware 140 determines that the instruction represents a policy violation (e.g., based on no match in the rule table 144, followed by a response from the policy processor 150 indicating a policy violation has been found), the tag processing hardware 140 may indicate to the write interlock 112 that a result of executing the instruction should be discarded, instead of being written back to memory. Additionally, or alternatively, the tag processing hardware 140 may send an interrupt to the host processor 110. In response to receiving the interrupt, the host processor 110 may switch to any suitable violation processing code. For example, the host processor 100 may halt, reset, log the violation and continue, perform an integrity check on application code and/or application data, notify an operator, etc.

In some embodiments, the rule table 144 may be implemented with a hash function and a designated portion of a memory (e.g., the metadata memory 125). For instance, a hash function may be applied to one or more inputs to the rule table 144 to generate an address in the metadata memory 125. A rule entry corresponding to the one or more inputs may be stored to, and/or retrieved from, that address in the metadata memory 125. Such an entry may include the one or more inputs and/or one or more corresponding outputs, which may be computed from the one or more inputs at run time, load time, link time, or compile time.

In some embodiments, the tag processing hardware 140 may include one or more configuration registers. Such a register may be accessible (e.g., by the policy processor 150) via a configuration interface of the tag processing hardware 140. In some embodiments, the tag register file 146 may be implemented as configuration registers. Additionally, or alternatively, there may be one or more application configuration registers and/or one or more metadata configuration registers.

Although details of implementation are shown in FIG. 1 and described above, it should be appreciated that aspects of the present disclosure are not limited to using any particular component, or combination of components, or to any particular arrangement of components. For instance, in some embodiments, one or more functionalities of the policy processor 150 may be performed by the host processor 110. As an example, the host processor 110 may have different operating modes, such as a user mode for user applications and a privileged mode for an operating system. Policy-related code (e.g., tagging, evaluating policies, etc.) may run in the same privileged mode as the operating system, or a different privileged mode (e.g., with even more protection against privilege escalation).

Additionally, or alternatively, one or more functionalities implemented in software (e.g., via instructions executed by a processor, or otherwise at software speed) may instead be implemented in hardware (e.g., via one or more FPGAs and/or fabricated logic, or otherwise at hardware speed), and/or vice versa. For instance, one or more functionalities implemented by the policy processor 150 may instead be implemented by the tag processing hardware 140, and/or vice versa.

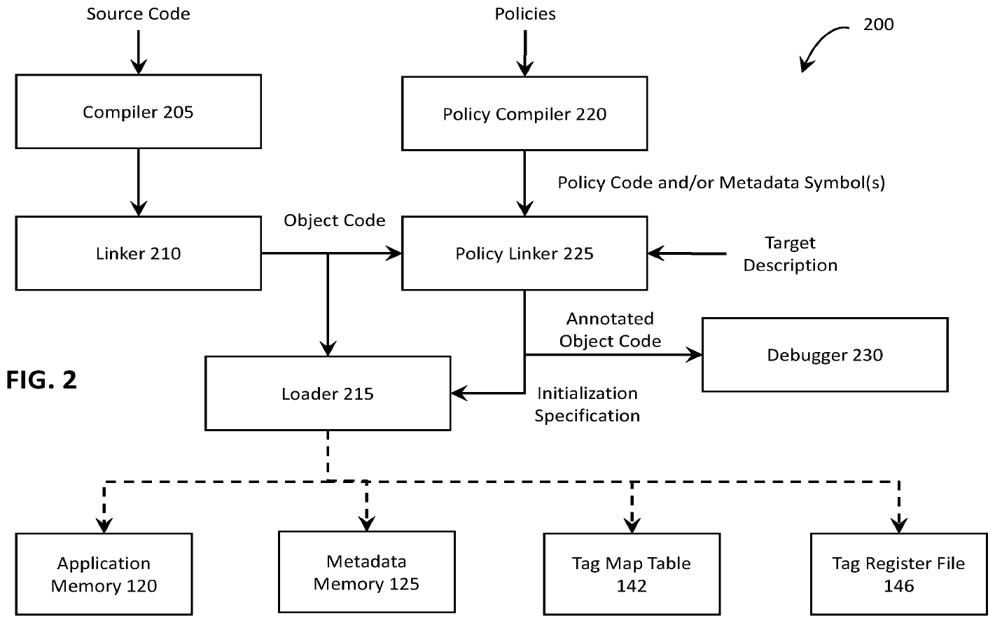

FIG. 2 shows an illustrative software system 200 for enforcing policies, in accordance with some embodiments. For instance, the software system 200 may be programmed to generate executable code and/or load the executable code into the illustrative hardware system 100 in the example of FIG. 1.

In the example shown in FIG. 2, the software system 200 includes a software toolchain having a compiler 205, a linker 210, and a loader 215. The compiler 205 may be programmed to process source code into executable code, where the source code may be in a higher-level language and the executable code may be in a lower level language. The linker 210 may be programmed to combine multiple object files generated by the compiler 205 into a single object file to be loaded by the loader 215 into memory (e.g., the illustrative application memory 120 in the example of FIG. 1). Although not shown, the object file output by the linker 210 may be converted into a suitable format and stored in persistent storage, such as flash memory, hard disk, read-only memory (ROM), etc. The loader 215 may retrieve the object file from the persistent storage, and load the object file into random-access memory (RAM).

In some embodiments, the compiler 205 may be programmed to generate information for use in enforcing policies. For instance, as the compiler 205 translates source code into executable code, the compiler 205 may generate information regarding data types, program semantics and/or memory layout. As one example, the compiler 205 may be programmed to mark a boundary between one or more instructions of a function and one or more instructions that implement calling convention operations (e.g., passing one or more parameters from a caller function to a callee function, returning one or more values from the callee function to the caller function, storing a return address to indicate where execution is to resume in the caller function's code when the callee function returns control back to the caller function, etc.). Such boundaries may be used, for instance, during initialization to tag certain instructions as function prologue or function epilogue. At run time, a stack policy may be enforced so that, as function prologue instructions execute, certain locations in a call stack (e.g., where a return address is stored) may be tagged as FRAME locations, and as function epilogue instructions execute, the FRAME metadata tags may be removed. The stack policy may indicate that instructions implementing a body of the function (as opposed to function prologue and function epilogue) only have read access to FRAME locations. This may prevent an attacker from overwriting a return address and thereby gaining control.

As another example, the compiler 205 may be programmed to perform control flow analysis, for instance, to identify one or more control transfer points and respective destinations. Such information may be used in enforcing a control flow policy. As yet another example, the compiler 205 may be programmed to perform type analysis, for example, by applying type labels such as Pointer, Integer, Floating-Point Number, etc. Such information may be used to enforce a policy that prevents misuse (e.g., using a floating-point number as a pointer).

Although not shown in FIG. 2, the software system 200 may, in some embodiments, include a binary analysis component programmed to take, as input, object code produced by the linker 210 (as opposed to source code), and perform one or more analyses similar to those performed by the compiler 205 (e.g., control flow analysis, type analysis, etc.).

In the example of FIG. 2, the software system 200 further includes a policy compiler 220 and a policy linker 225. The policy compiler 220 may be programmed to translate one or more policies written in a policy language into policy code. For instance, the policy compiler 220 may output policy code in C or some other suitable programming language. Additionally, or alternatively, the policy compiler 220 may output one or more metadata labels referenced by the one or more policies. At initialization, such a metadata label may be associated with one or more memory locations, registers, and/or other machine state of a target system, and may be resolved into a binary representation of metadata to be loaded into a metadata memory or some other hardware storage (e.g., registers) of the target system. As discussed above, such a binary representation of metadata, or a pointer to a location at which the binary representation is stored, may be referred to herein as a “metadata tag.”

It should be appreciated that aspects of the present disclosure are not limited to resolving metadata labels at load time. In some embodiments, one or more metadata labels may be resolved statically (e.g., at compile time or link time). For example, the policy compiler 220 may process one or more applicable policies, and resolve one or more metadata labels defined by the one or more policies into a statically-determined binary representation. Additionally, or alternatively, the policy linker 225 may resolve one or more metadata labels into a statically-determined binary representation, or a pointer to a data structure storing a statically-determined binary representation. The inventors have recognized and appreciated that resolving metadata labels statically may advantageously reduce load time processing. However, aspects of the present disclosure are not limited to resolving metadata labels in any particular manner.

In some embodiments, the policy linker 225 may be programmed to process object code (e.g., as output by the linker 210), policy code (e.g., as output by the policy compiler 220), and/or a target description, to output an initialization specification. The initialization specification may be used by the loader 215 to securely initialize a target system having one or more hardware components (e.g., the illustrative hardware system 100 in the example of FIG. 1) and/or one or more software components (e.g., an operating system, one or more user applications, etc.).

In some embodiments, the target description may include descriptions of a plurality of named entities. A named entity may represent a component of a target system. As one example, a named entity may represent a hardware component, such as a configuration register, a program counter, a register file, a timer, a status flag, a memory transfer unit, an input/output device, etc. As another example, a named entity may represent a software component, such as a function, a module, a driver, a service routine, etc.

In some embodiments, the policy linker 225 may be programmed to search the target description to identify one or more entities to which a policy pertains. For instance, the policy may map certain entity names to corresponding metadata labels, and the policy linker 225 may search the target description to identify entities having those entity names. The policy linker 225 may identify descriptions of those entities from the target description, and use the descriptions to annotate, with appropriate metadata labels, the object code output by the linker 210. For instance, the policy linker 225 may apply a Read label to a .rodata section of an Executable and Linkable Format (ELF) file, a Read label and a Write label to a .data section of the ELF file, and an Execute label to a .text section of the ELF file. Such information may be used to enforce a policy for memory access control and/or executable code protection (e.g., by checking read, write, and/or execute privileges).

It should be appreciated that aspects of the present disclosure are not limited to providing a target description to the policy linker 225. In some embodiments, a target description may be provided to the policy compiler 220, in addition to, or instead of, the policy linker 225. The policy compiler 220 may check the target description for errors. For instance, if an entity referenced in a policy does not exist in the target description, an error may be flagged by the policy compiler 220. Additionally, or alternatively, the policy compiler 220 may search the target description for entities that are relevant for one or more policies to be enforced, and may produce a filtered target description that includes entities descriptions for the relevant entities only. For instance, the policy compiler 220 may match an entity name in an “init” statement of a policy to be enforced to an entity description in the target description, and may remove from the target description (or simply ignore) entity descriptions with no corresponding “init” statement.

In some embodiments, the loader 215 may initialize a target system based on an initialization specification produced by the policy linker 225. For instance, referring to the example of FIG. 1, the loader 215 may load data and/or instructions into the application memory 120, and may use the initialization specification to identify metadata labels associated with the data and/or instructions being loaded into the application memory 120. The loader 215 may resolve the metadata labels in the initialization specification into respective binary representations. However, it should be appreciated that aspects of the present disclosure are not limited to resolving metadata labels at load time. In some embodiments, a universe of metadata labels may be known during policy linking, and therefore metadata labels may be resolved at that time, for example, by the policy linker 225. This may advantageously reduce load time processing of the initialization specification.

In some embodiments, the policy linker 225 and/or the loader 215 may maintain a mapping of binary representations of metadata back to human-readable versions of metadata labels. Such a mapping may be used, for example, by a debugger 230. For instance, in some embodiments, the debugger 230 may be provided to display a human-readable version of an initialization specification, which may list one or more entities and, for each entity, a set of one or more metadata symbols associated with the entity. Additionally, or alternatively, the debugger 230 may be programmed to display assembly code annotated with metadata labels, such as assembly code generated by disassembling object code annotated with metadata labels. During debugging, the debugger 230 may halt a program during execution, and allow inspection of entities and/or metadata tags associated with the entities, in human-readable form. For instance, the debugger 230 may allow inspection of entities involved in a policy violation and/or metadata tags that caused the policy violation. The debugger 230 may do so using the mapping of binary representations of metadata back to metadata labels.

In some embodiments, a conventional debugging tool may be extended to allow review of issues related to policy enforcement, for example, as described above. Additionally, or alternatively, a stand-alone policy debugging tool may be provided.

In some embodiments, the loader 215 may load the binary representations of the metadata labels into the metadata memory 125, and may record the mapping between application memory addresses and metadata memory addresses in the tag map table 142. For instance, the loader 215 may create an entry in the tag map table 142 that maps an application memory address where an instruction is stored in the application memory 120, to a metadata memory address where metadata associated with the instruction is stored in the metadata memory 125. Additionally, or alternatively, the loader 215 may store metadata in the tag map table 142 itself (as opposed to the metadata memory 125), to allow access without performing any memory operation.

In some embodiments, the loader 215 may initialize the tag register file 146 in addition to, or instead of, the tag map table 142. For instance, the tag register file 146 may include a plurality of registers corresponding, respectively, to a plurality of entities. The loader 215 may identify, from the initialization specification, metadata associated with the entities, and store the metadata in the respective registers in the tag register file 146.

Referring again to the example of FIG. 1, the loader 215 may, in some embodiments, load policy code (e.g., as output by the policy compiler 220) into the metadata memory 125 for execution by the policy processor 150. Additionally, or alternatively, a separate memory (not shown in FIG. 1) may be provided for use by the policy processor 150, and the loader 215 may load policy code and/or associated data into the separate memory.

In some embodiments, upon completion of loading of metadata and policy code, the loader 215 may notify the illustrative tag processing hardware 140 in the example of FIG. 1. In response, the tag processing hardware 140 may begin enforcing one or more policies according to the metadata and the policy code.

In some embodiments, a metadata label may be based on multiple metadata symbols. For instance, an entity may be subject to multiple policies, and may therefore be associated with different metadata symbols corresponding, respectively, to the different policies. The inventors have recognized and appreciated that it may be desirable that a same set of metadata symbols be resolved by the loader 215 to a same binary representation (which may be referred to herein as a “canonical” representation). For instance, a metadata label {A, B, C} and a metadata label {B, A, C} may be resolved by the loader 215 to a same binary representation. In this manner, metadata labels that are syntactically different but semantically equivalent may have the same binary representation.

The inventors have further recognized and appreciated it may be desirable to ensure that a binary representation of metadata is not duplicated in metadata storage. For instance, as described above, the illustrative rule table 144 in the example of FIG. 1 may map input metadata tags to output metadata tags, and, in some embodiments, the input metadata tags may be metadata memory addresses where binary representations of metadata are stored, as opposed to the binary representations themselves. The inventors have recognized and appreciated that if a same binary representation of metadata is stored at two different metadata memory addresses X and Y, the rule table 144 may not recognize an input pattern having the metadata memory address Y as matching a stored mapping having the metadata memory address X. This may result in a large number of unnecessary rule misses, which may degrade system performance.

Moreover, the inventors have recognized and appreciated that having a one-to-one correspondence between binary representations of metadata and their storage locations may facilitate metadata comparison. For instance, equality between two pieces of metadata may be determined simply by comparing metadata memory addresses, as opposed to comparing binary representations of metadata. This may result in significant performance improvement, especially where the binary representations are large (e.g., many metadata symbols packed into a single metadata label).

Accordingly, in some embodiments, the loader 215 may, prior to storing a binary representation of metadata (e.g., into the illustrative metadata memory 125 in the example of FIG. 1), check if the binary representation of metadata has already been stored. If the binary representation of metadata has already been stored, instead of storing it again at a different storage location, the loader 215 may refer to the existing storage location. Such a check may be done at startup and/or when a program is loaded subsequent to startup (with or without dynamic linking).

Additionally, or alternatively, a similar check may be performed when a binary representation of metadata is created as a result of evaluating one or more policies (e.g., by the illustrative policy processor 150 in the example of FIG. 1). If the binary representation of metadata has already been stored, a reference to the existing storage location may be used (e.g., installed in the illustrative rule table 144 in the example of FIG. 1).

In some embodiments, the loader 215 may create a hash table mapping hash values to storage locations. Before storing a binary representation of metadata, the loader 215 may use a hash function to reduce the binary representation of metadata into a hash value, and check if the hash table already contains an entry associated with the hash value. If so, the loader 215 may determine that the binary representation of metadata has already been stored, and may retrieve, from the entry, information relating to the binary representation of metadata (e.g., a pointer to the binary representation of metadata, or a pointer to that pointer). If the hash table does not already contain an entry associated with the hash value, the loader 215 may store the binary representation of metadata (e.g., to a register or a location in a metadata memory), create a new entry in the hash table in association with the hash value, and store appropriate information in the new entry (e.g., a register identifier, a pointer to the binary representation of metadata in the metadata memory, a pointer to that pointer, etc.). However, it should be appreciated that aspects of the present disclosure are not limited to using a hash table to keep track of binary representations of metadata that have already been stored. Additionally, or alternatively, other data structures may be used, such as a graph data structure, a sorted list, an unsorted list, etc. Any suitable data structure or combination of data structures may be selected based on any suitable criterion or combination of criteria, such as access time, memory usage, etc.

It should be appreciated that the techniques introduced above and/or described in greater detail below may be implemented in any of numerous ways, as these techniques are not limited to any particular manner of implementation. Examples of implementation details are provided herein solely for purposes of illustration. Furthermore, the techniques disclosed herein may be used individually or in any suitable combination, as aspects of the present disclosure are not limited to any particular technique or combination of techniques.

For instance, while examples are described herein that include a compiler (e.g., the illustrative compiler 205 and/or the illustrative policy compiler 220 in the example of FIG. 2), it should be appreciated that aspects of the present disclosure are not limited to using a compiler. In some embodiments, a software toolchain may be implemented as an interpreter. For example, a lazy initialization scheme may be implemented, where one or more default labels (e.g., DEFAULT, PLACEHOLDER, etc.) may be used for tagging at startup, and a policy processor (e.g., the illustrative policy processor 150 in the example of FIG. 1) may evaluate one or more policies and resolve the one or more default labels in a just-in-time manner.

In some embodiments, a finite state machine (FSM) may include one or more states and/or one or more transitions. A transition may have a source state and a target state. The source state and the target state may be the same state, or different states. Pictorially, an FSM may be represented as a directed graph in which nodes represent states and edges represent transitions between states.

The inventors have recognized and appreciated that state machines provide a natural way to express desired behavior of a system. For instance, a safety property may be expressed based on a set of states that are designated as being safe, and/or a set of transitions that are designated as being allowed. An allowed transition may be such that, if a system starts in a safe state and takes the allowed transition, the system may end in a safe state (which may be the same as, or different from, the start state). In this manner, a formal proof may be given that the safety property will always be satisfied as long as the system is initialized to a safe state and only takes allowed transitions.

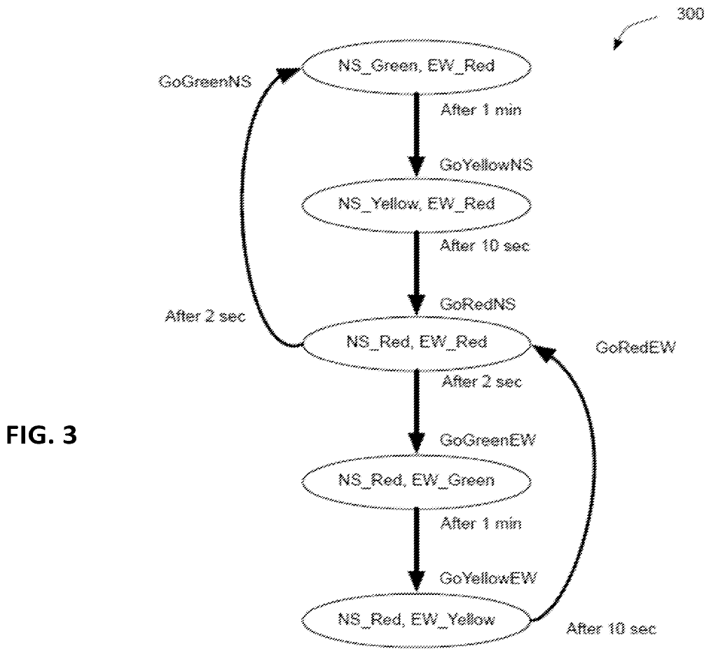

FIG. 3 shows an illustrative FSM 300, in accordance with some embodiments. For instance, the FSM 300 may represent a safety policy for a traffic light controller at a four-way intersection, where a light facing north and a light facing south may always show a same color, and likewise for a light facing east and a light facing west. The safety policy may indicate that if the north-south lights are not red (e.g., green or yellow), then the east-west lights must be red, and vice versa. Thus, the north-south lights and the east-west lights may never be all green simultaneously.

In the example of FIG. 3, the FSM 300 has two state variables: color of the north-south lights and color of the east-west lights. Each state variable may have three possible values: red, yellow, and green. The green-yellow, yellow-green, yellow-yellow and green-green states do not appear in FIG. 3 because such states are considered to be safety violations in this example. Thus, there may be only five safe states.

In some embodiments, the FSM 300 may have transitions that each represent a set of lights turning a selected color. For instance, after the FSM 300 has been in the green-red state for one minute, a transition may take place, representing the north-south lights turning from green to yellow, while the east-west lights remain red. This may cause the FSM 300 to enter in the yellow-red state.

In some embodiments, the FSM 300 may be translated into a policy. For example, the policy may include metadata symbols that correspond to values of state variables of the FSM 300. At run time, a metadata tag encoding one or more of these metadata symbols may be written to a memory location (e.g., a location in the illustrative metadata memory 125 in the example of FIG. 1) accessible to tag processing hardware (e.g., the illustrative tag processing hardware 140). For instance, one or more of these metadata symbols may be written to a memory location allocated for a metadata variable (e.g., an environment variable) maintained by the tag processing hardware 140 for policy checking purposes. Examples of state metadata symbols for the FSM 300 may include the following.

```
metadata:
    / / Metadata to represent light states
data (Data) NS_T<fixed> = NS_Red
                  | NS_Yellow
                  | NS_Green
data (Data) EW_T<fixed> = EW_Red
                  | EW_Yellow
                  | EW_Green
```

In this example, each value of each state variable is assigned a metadata symbol. Thus, a state of the FSM 300 may be represented as a pair of symbols, such as [NS_Red, EW_Green]. However, that is not required. In some embodiments, individual symbols may be used for combined colors, such as NS_Red_&_EW_Green.

Additionally, or alternatively, the policy may include metadata symbols that correspond to transitions in the FSM 300. At run time, one or more of these metadata symbols may be used to label application code executed by the traffic light controller. For instance, one or more of these metadata symbols may be written to a metadata memory location (e.g., a location in the illustrative metadata memory 125 in the example of FIG. 1) accessible to tag processing hardware (e.g., the illustrative tag processing hardware 140). The metadata memory location may be associated (e.g., via the illustrative tag map table 142) with an application memory location (e.g., a location in the illustrative application memory 120). The application code to be labeled by the one or more metadata symbols may be stored at the application memory location. Examples of transition metadata symbols for the FSM 300 may include the following.

```
metadata:
      / / Metadata to label code functions
data (Instruction) Transition_T<fixed> = GoGreenNS
                          | GoGreenEW
                          | GoRedNS
                          | GoRedEW
                          | GoYellowNS
                          | GoYellowEW
```

In some embodiments, transitions in the FSM 300 may be translated into policy rules, such as one or more of the following policy rules.

```
policy:
      signalSafety =
      rule_1(code == [+GoGreenNS], env == [NS_Red, EW_Red] −>
            env = {NS_Green, EW_Red})
    \hat{ } rule_2(code == [+GoGreenEW], env == [NS_Red, EW_Red] −>
            env = {NS_Red, EW_Green})
    \hat{ } rule_3(code == [+GoYellowNS], env == [NS_Green, EW_Red] −>
            env = {NS_Yellow, EW_Red})
    \hat{ } rule_4(code == [+GoYellowEW], env == [NS_Red, EW_Green] −>
            env = {NS_Red, EW_Yellow})
    \hat{ } rule 5(code == [+GoRedNS], env == [NS_Yellow, EW_Red] −>
            env = {NS_Red, EW_Red})
    \hat{ } rule_6(code == [+GoRedEW], env == [NS_Red, EW_Yellow] −>
            env = {NS_Red, EW_Red})
    \hat{ } rule_self(code == [−GoGreenNS, −GoGreenEW,
                      −GoYellowNS, −GoYellowEW,
            −GoRedNS, −GoRedEW], env == _ −>
    env = env)
```

In this example, a policy rule may start with a rule name (e.g., “rule_1”), which may simply identify the policy rule for debugging purposes.

In some embodiments, the “code== . . . ” portion of the policy rule may indicate one or more transition metadata symbols (e.g., “GoGreenNS”). At run time, the tag processing hardware 140 may check if a metadata label associated with an instruction executed by a host processor (e.g., the illustrative host processor 110) matches the one or more transition metadata symbols indicated in the “code== . . . ” portion of the policy rule.

In some embodiments, the “env== . . . ” portion of the policy rule (before the right arrow) may indicate one or more state metadata symbols (e.g., “NS_Red, EW_Red”). At run time, the tag processing hardware 140 may check if a metadata label associated with a state of the host processor 110 matches the one or more state metadata symbols indicated in the “env== . . . ” portion of the policy rule. The state of the host processor may include one or more registers, such as a program counter, a control and status register, etc.

In the last policy rule of this example, the underscore character may indicate a wildcard. For instance, the expression “env==_” may indicate that the policy rule may be triggered regardless of what metadata label is associated with the state of the host processor 110.

In some embodiments, if the metadata label associated with the instruction matches the one or more transition metadata symbols indicated in the “code== . . . ” portion of the policy rule, and the metadata label associated with the state of the host processor 110 matches the one or more state metadata symbols indicated in the “env== . . . ” portion of the policy rule, then the tag processing hardware 140 may determine that the instruction is allowed.

In some embodiments, the “env= . . . ” portion of the policy rule (after the right arrow) may indicate one or more state metadata symbols (e.g., “NS_Green, EW_Red”). At run time, if the tag processing hardware 140 determines that the instruction is allowed, the tag processing hardware may update the metadata label associated with the state of the host processor 110 with the one or more state metadata symbols indicated in the “env= . . . ” portion of the policy rule. In this manner, the metadata label associated with the state of the host processor 110 may be used by the tag processing hardware 140 to keep track of state of the FSM 300 while the tag processing hardware 140 executes the FSM 300 at run time, alongside the application code of the traffic light controller.

The policy rules in the above example may be described as follows.
1. The first policy rule may represent the north-south lights turning green from a state in which all lights are red, resulting in a state in which the north-south lights are green, and the east-west lights are red.
2. The second policy rule may represent the east-west lights turning green from the state in which all lights are red, resulting in a state in which the north-south lights are red, and the east-west lights are green.
3. The third policy rule may represent the north-south lights turning yellow from the state in which the north-south lights are green, and the east-west lights are red, resulting in a state in which the north-south lights are yellow, and the east-west lights are red.
4. The fourth policy rule may represent the east-west lights turning yellow from the state in which the north-south lights are red, and the east-west lights are green, resulting in a state in which the north-south lights are red, and the east-west lights are yellow.
5. The fifth policy rule may represent the north-south lights turning red from the state in which the north-south lights are yellow, and the east-west lights are red, resulting in the state in which all lights are red.
6. The sixth policy rule may represent the east-west lights turning red from the state in which the north-south lights are red, and the east-west lights are yellow, resulting in the state in which all lights are red.
7. The seventh policy rule may indicate that all instructions not labeled with any of the transition metadata symbols (i.e., GoGreenNS, GoGreenEW, GoYellowNS, GoYellowEW, GoRedNS, and GoRedEW) may be allowed to execute, and may not cause any state change. This may correspond to a self-transition at each state, usually depicted as an arrow looping back to the same state, implicit in the illustrative FSM 300 shown in FIG. 3.

The inventors have recognized and appreciated that a state machine that represents desired behavior of an application may be simpler than full implementation code, and therefore may be easier to verify. In some embodiments, formal methods tools may be used to prove various properties of state machines, such as safety properties, spatial properties (e.g., information flow), temporal properties (e.g., execution ordering), etc. However, it should be appreciated that aspects of the present disclosure are not limited to checking any particular property of a state machine, or to using any state machine at all.

As described above in connection with the example of FIG. 1, the illustrative tag processing hardware 140 may send a query to the illustrative policy processor 150 to check if an instruction executed by the illustrative host processor 110 is allowed. The query may include one or more inputs, such as an instruction type (e.g., opcode) of the instruction, a metadata tag for a program counter, a metadata tag for an application memory address from which the instruction is fetched (e.g., a word in memory to which the program counter points), a metadata tag for a register in which an operand of the instruction is stored, and/or a metadata tag for an application memory address referenced by the instruction.

In some embodiments, the policy processor 150 may have loaded therein one or more policies, such as the illustrative signalsafety policy described above in connection with the example of FIG. 3. In response to a query from the tag processing hardware 140, the policy processor 150 may evaluate one or more of the policies based on one or more inputs in the query from the tag processing hardware 140, to determine if an instruction giving rise to the query is allowed. If the instruction is not allowed, the policy processor 150 may so notify the tag processing hardware 140. If the instruction is allowed, the policy processor 150 may compute one or more outputs to be returned to the tag processing hardware 140. Additionally, or alternatively, the policy processor 150 may store the one or more inputs and/or the one or more corresponding outputs in the illustrative rule table 144 for future reference.

It should be appreciated that an entry in the rule table 144 may be different from a policy rule in a policy. Indeed, a single policy rule may sometimes induce multiple entries in the rule table 144. For instance, the following rule in the signalsafety policy may induce multiple entries, where each entry may correspond to a self-transition at a respective state in the illustrative FSM 300 in the example of FIG. 3.

```
rule_self(code == [−GoGreenNS, −GoGreenEW,
                  −GoYellowNS, −GoYellowEW,
                  −GoRedNS, −GoRedEW], env == _ −>
        env = env)
```

Assuming no other policy is concurrently enforced, the induced rule entries may be represented (in human-readable form) as follows.

<{ }, {NS_Red, EW_Red}, {NS_Red, EW_Red}>
<{ }, {NS_Green, EW_Red}, {NS_Green, EW_Red}>
<{ }, {NS_Yellow, EW_Red}, {NS_Yellow, EW_Red}>
<{ }, {NS_Red, EW_Green}, {NS_Red, EW_Green}>
<{ }, {NS_Red, EW_Green}, {NS_Red, EW_Green}>

In this example, there are three slots in each rule entry, where each slot has an associated metadata label. The first slot may be designated for the input code, the second slot may be designated for the input env, and the third slot may be designated for the output env. However, it should be appreciated that aspects of the present disclosure are not limited to having any particular number of input slot(s), or at all. Likewise, aspects of the present disclosure are not limited to having any particular number of output slot(s), or at all.

Policy rules in a policy may be referred to herein as “symbolic” rules. A symbolic rule may be instantiated with different combinations of metadata labels to obtain different “concrete” rules. For example, the policy rule rule_self above may be instantiated in five different ways to obtain five concrete rules corresponding, respectively, to the five rule entries above. Thus, rule entries may be examples of concrete rules.

The inventors have recognized and appreciated that the policy processor 150 may, in some instances, execute hundreds (or even thousands) of instructions to evaluate one or more policies on just one instruction executed by the host processor 110. Accordingly, in some embodiments, the host processor 110 may be stalled to allow the policy processor 150 to catch up. However, this may create a delay that may be undesirable for some real time applications. For example, the host processor 110 may be on an electric vehicle, and may control circuit switching that takes place thousands of times per second to keep an electric motor running smoothly. Such time sensitive control operations may be disrupted if the host processor 110 is stalled waiting for policy evaluation to be completed.

The inventors have further recognized and appreciated that, although the rule table 144 may be used to speed up accesses to concrete rules, such a speedup may be available only after a concrete rule has already been computed by the policy processor 150 and installed into the rule table 144. When the tag processing hardware 140 queries the rule table 144 with a certain pattern of one or more inputs for the first time, the rule table 144 may indicate there is no match, and the tag processing hardware 140 may request that the policy processor 150 perform policy evaluation on the one or more inputs, which may cause an undesirable delay.

Accordingly, in some embodiments, one or more concrete rules may be computed and installed into a rule table before run time. For instance, the illustrative policy compiler 220 in the example of FIG. 2 may be programmed to compute one or more concrete rules at compile time. Additionally, or alternatively, the illustrative policy linker 225 may be programmed to compute one or more concrete rules at link time. The illustrative loader 215 may resolve metadata labels in the one or more concrete rules computed by the policy compiler 220 and/or the policy linker 225 into binary representations, and may load the one or more concrete rules (with binary representations substituted for the respective metadata labels) into the rule table 144. In this manner, the one or more concrete rules may be made available at run time without invoking the policy processor 150.

However, the inventors have recognized and appreciated a number of challenges in computing and installing concrete rules before run time. For instance, the inventors have recognized and appreciated that a number of possible metadata labels may grow exponentially with a number of distinct metadata symbols. With reference to the illustrative signalsafety policy in the example of FIG. 3, there may be 12 distinct metadata symbols, including six state metadata symbols (i.e., NS_Green, EW_Green, NS_Yellow, EW_Yellow, NS_Red, and EW_Red) and six transition metadata symbols (i.e., GoGreenNS, GoGreenEW, GoYellowNS, GoYellowEW, GoRedNS, and GoRedEW). Thus, 2\hat{ }12=4096 different metadata labels may be generated, each label corresponding to a different subset of the 12 metadata symbols.¹ The same analysis may apply to a composite policy where the component policies collectively use 12 distinct metadata symbols.

Moreover, since each symbolic rule in the signalsafety policy may have two inputs (e.g., code and env), a total of 4096\hat{ }2=16,777,216 different input patterns may be possible. For a similar policy with three inputs (e.g., code and env, along with mem, a metadata label associated with an application memory location referenced by the instruction being checked), a total of 4096\hat{ }3=68,719,476,736 different input patterns may be possible. It may not be practical to evaluate each of these input patterns to determine if the input pattern leads to a concrete rule that should be installed into the rule table 144.

Accordingly, in some embodiments, techniques are provided for identifying input patterns that may correspond to concrete rules to be installed into a rule table. For instance, a policy language may be provided with one or more features that may be used (e.g., by the policy compiler 220) to identify certain input patterns for which concrete rules may be computed ahead of time, and/or certain input patterns for which concrete rules may not be computed ahead of time.

The inventors have recognized and appreciated that, for a concrete rule that is computed ahead of time, run time performance may be improved because the tag processing hardware 140 may be able to retrieve that concrete rule from the rule table 144 without invoking the policy processor 150. On the other hand, for a concrete rule that is not computed ahead of time, the tag processing hardware 140 may not find a match in the rule table 144, and may, in response, simply query the policy processor 150. Thus, run time performance may be no worse than that observed in an implementation where no pre-computation is performed.

In sum, computing and installing concrete rules before run time may improve run time performance in some cases, without imposing any penalty in other cases. Moreover, because a concrete rule may be computed in the same way regardless of when the computation takes place (e.g., either before or at run time), there may be no negative impact to security, safety, or any other relevant property.

In some embodiments, a policy language may be provided that allows a policy author to declare a new metadata type T as a sum of a plurality of other metadata types S₀, S₁, . . .

T=Sum(S₀,S₁, . . . )

With reference to the illustrative signalsafety policy, a new sum type NS_T may be declared as follows.

```
data (Data) NS_T<fixed> = NS_Red
                  | NS_Yellow
                  | NS_Green
```

In some embodiments, the policy compiler 220 and/or the policy linker 225 may be programmed to generate possible metadata labels for the type NS_T as follows.
{ }, {NS_Green}, {NS_Yellow}, {NS_Red}

Thus, a metadata label of the type NS_T may include either no metadata symbol, or exactly one of the metadata symbols NS_Green, NS_Yellow, and NS_Red. Subsets with multiple elements (i.e., {NS_Green, NS_Yellow}, (NS_Yellow, NS_Red), {NS_Green, NS_Red} and {NS_Red, NS_Yellow, NS_Green}) may be excluded. This semantics may be suitable for the signalsafety policy because it may be assumed that a traffic light may not show multiple colors simultaneously.

The inventors have recognized and appreciated that, with the above described semantics, a number of possible metadata labels for a sum type T=Sum (S₀, S₁, . . . , S_{N}), where each S₁ includes a distinct metadata symbol, may grow linearly with N, as opposed to exponentially with N. This may in turn reduce a number of concrete rules to be computed and installed ahead of time.

In some embodiments, a policy language may be provided that allows a policy author to assign a domain to a metadata type T. With reference to the above example, the metadata type NS_T may be assigned a domain Data.

Additionally, or alternatively, a new metadata type EW_T may be declared as follows, with the Data domain.

```
data (Data) EW_T<fixed> = EW_Red
                  | EW_Yellow
                  | EW_Green
```

Additionally, or alternatively, a new metadata type Transition_T may be declared as follows, with a domain Instruction.

```
data (Instruction) Transition_T<fixed> = GoGreenNS
                          | GoGreenEW
                          | GoRedNS
                          | GoRedEW
                          | GoYellowNS
                          | GoYellowEW
```

In some embodiments, the policy compiler 220 and/or the policy linker 225 may be programmed to generate possible metadata labels such that no metadata symbol assigned the Data domain may appear in a same metadata label as a metadata symbol assigned the Instruction domain. Thus, a subset such as {NS_Green, EW_Yellow} may be included, but a subset such as {NS_Green, GoYellowNS} may be excluded. This semantics may be suitable for the signalSafety policy because transition metadata symbols may be used to label instructions but not state variables, whereas state metadata symbols may be used to label state variables but not instructions.

The inventors have recognized and appreciated that, with both the illustrative sum type feature and the illustrative domain feature described above, only 6*9=54 different metadata labels may be generated (6 possibilities for the instruction domain and 3*3=9 possibilities for the Data domain), as opposed to 4096 different metadata labels. For a policy with two inputs, a total of 54\hat{ }2=2,916 different input patterns may be possible, which is a significant reduction from 4096\hat{ }2=16,777,216 different input patterns. Likewise, for a policy with three inputs, a total of 54\hat{ }3=157,464 different input patterns may be possible, which is a significant reduction from 4096\hat{ }3=68,719,476,736 different input patterns. However, it should be appreciated that aspects of the present disclosure are not limited to using a policy language with a sum type feature or a domain feature, or any policy language at all.

The inventors have further recognized and appreciated that, in some instances, it may be known ahead of time that a certain input may only be associated with metadata labels from a certain domain. With reference to the signalsafety policy, the code input may be associated with the instruction domain, whereas the env input may be associated with the Data domain.

// Field declarations
field env : Data
field code : Instruction

Thus, only 6*9=54 different input patterns may be possible (6 possibilities for code and 3*3=9 possibilities for env), which is a further reduction from 2,916 different input patterns. Even with three inputs, one associated with the instruction domain and two associated with the Data domain, only 6*9*9=486 different input patterns may be possible, which is a further reduction from 157,464 different input patterns.

The inventors have further recognized and appreciated that, in some instances, run time performance may not be of concern for disallowed instructions. For example, in response to determining that an instruction is disallowed (e.g., based on no match in the rule table 144, followed by a response from the policy processor 150 indicating a policy violation has been found), the tag processing hardware 140 may send an interrupt to the host processor 110, which may cause the host processor 110 to switch to suitable violation processing code. A delay caused by such a context switch and/or the violation processing code itself may be large relative to a delay caused by invoking the policy processor 150 to check the instruction.

By contrast, run time performance may be of significant concern for instructions that are allowed. For instance, in the electric motor example described above, the host processor may be responsible for controlling circuit switching thousands of times per second. All of the instructions associated with such control operations may be allowed instructions. Thus, it may be desirable to check allowed instructions in an efficient manner.

Accordingly, in some embodiments, the policy compiler 220 and/or the policy linker may be programmed to generate input patterns corresponding to allowed instructions. Additionally, or alternatively, the policy compiler 220 and/or the policy linker 225 may evaluate such input patterns to obtain corresponding output patterns. Resulting concrete rules may be installed into the rule table 144 for efficient access at run time.

The inventors have recognized and appreciated that input patterns corresponding to allowed instructions may be a small fraction of all possible input patterns. As such, it may be computationally feasible to evaluate all input patterns corresponding to allowed instructions, and to install resulting concrete rules into the rule table 144.

With reference to the signalsafety policy, assuming both the illustrative sum type feature and the illustrative domain feature are used, and no other policy is enforced concurrently, each of the first 6 policy rules may be matched by exactly one input pattern. For instance, with respect to the policy rule “rule_1,” the policy compiler 220 and/or the policy linker 225 may determine that only one metadata label (i.e., {GoGreenNS}) may match “code==[+GoGreenNS],” and only one metadata label (i.e., {NS_Red, EW_Red}) may match “env==[NS_Red, EW_Red].”

Similarly, assuming that both the illustrative sum type feature and the illustrative domain feature are used, and that no other policy is enforced concurrently, the last policy rule may be matched by 9 input patterns. For instance, with respect to the policy rule “rule_self,” the policy compiler 220 and/or the policy linker 225 may determine that only one metadata label (i.e., the empty label { }) may match “code==[−GoGreenNS, −GoGreenEW, −GoYellowNS, −GoYellowEW, −GoRedNS, −GoRedEW],” and 3*3=9 metadata labels (3 possibilities from NS_T and 3 possibilities from EW_T) may match the wildcard for env.

Thus, only 6+9=15 input patterns may correspond to allowed instructions, which may be a small fraction of all 54 possible input patterns.

In some embodiments, the policy compiler 220 and/or the policy linker 225 may use a Boolean satisfiability solver to identify input patterns. For instance, a Boolean satisfiability solver may be used to identify one or more input patterns that trigger at least one symbolic rule in a policy. Any suitable Boolean satisfiability solver may be used, including, but not limited to, a satisfiability modulo theories (SMT) solver.

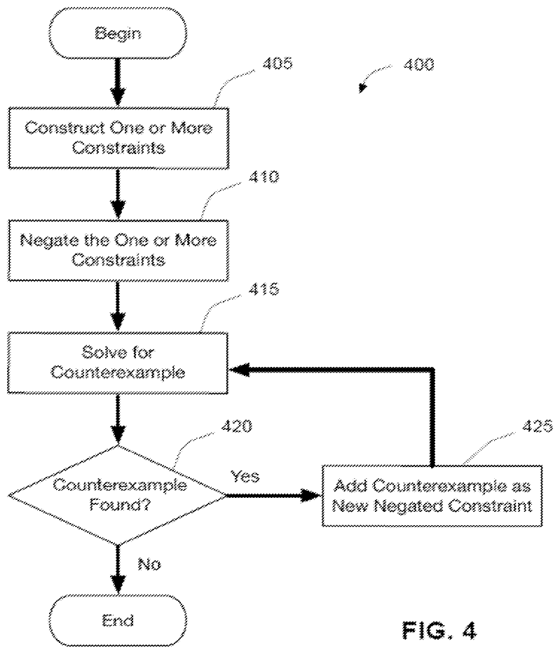

FIG. 4 shows an illustrative process 400 that may be used to identify one or more input patterns, in accordance with some embodiments. For instance, the process 400 may be used to identify one or more input patterns that each trigger at least one symbolic rule in the illustrative signalsafety policy described in connection with the example of FIG. 3.

At act 405, one or more constraints may be constructed based on a symbolic rule. In some embodiments, a constraint may be a condition having one or more Boolean variables corresponding, respectively, to one or more metadata symbols appearing in the symbolic rule. As an example, a plus “+” construct in the policy language may be translated into a Boolean equation. For instance, “code==[+GoGreenNS]” may be translated into a constraint code_GoGreenN=1 for the input code. In some embodiments, the “plus” construct may be inferred, so that “code==[GoGreenNS]” may also be translated into a constraint code_GoGreenN=1 for the input code.

As another example, a minus “−” construct in the policy language may be translated into a Boolean equation. For instance, “code==[−GoGreenNS]” may be translated into a constraint code_GoGreenN=O for the input code.

In some embodiments, a list of one or more plus “+” constructs and/or minus “−” constructs may be translated into a conjunction. For instance, “code==[−GoGreenNS, −GoGreenEW, −GoYellowNS, −GoYellowEW, −GoRedNS, −GoRedEW]” may be translated into a constraint for the input code as follows.

code_GoGreenN=0 and code_GoGreenEW=0 and
code_GoYellowNS=0 and
code_GoYellowEW=0 and code_GoRedNS=0 and
code_GoRedEW=0

In some embodiments, a list of one or more metadata symbols may be translated into a conjunction. For instance, “env==[NS_Red, EW_Red]” may be translated into a constraint for the input env as follows.
env_NS_Red=1 and env_EW_Red=1

In some embodiments, two constraints constructed based on a same symbolic rule, but for different inputs, may be combined via a conjunction. Consider, for example, the policy rule “rule_1” in the signalSafety policy.

rule_1 (code == [+GoGreenNS], env == [NS_Red, EW_Red] −>
env = {NS_Green, EW_Red} )

The two conditions in this rule, “code==[+GoGreenNS]” and “env==[NS_Red, EW_Red],” may be translated into the following conjunction, with prefixes “code” and “env” differentiating Boolean variables corresponding to the input code and the input env, respectively.

Illustrative Constraint (1)
(code_GoGreenNS=1) and
(env_NS_Red=1 and env_EW_Red=1)

In some embodiments, a constraint may be constructed based on a sum type. For instance, a constraint based on the sum type NS_T may be expressed in disjunctive normal form as follows.

(NS_Red=1 and NS_Yellow=0 and NS_Green=0) or
(NS_Red=0 and NS_Yellow=1 and NS_Green=0) or
(NS_Red=0 and NS_Yellow=0 and NS_Green=1) or
(NS_Red=0 and NS_Yellow=0 and NS_Green=0)

Additionally, or alternatively, a constraint based on the sum type NS_T may be expressed in conjunctive normal form as follows.

(NS_Red=0 or NS_Yellow=0) and
(NS_Red=0 or NS_Green=0) and
(NS_Yellow=0 or NS_Green=0)

However, it should be appreciated that aspects of the present disclosure are not limited to using disjunctive normal form or conjunctive normal form, or any particular logical form. In some embodiments, an equivalent formula may be used, such as the following.

not (NS_Red=1 and NS_Yellow=1) and
not (NS_Red=1 and NS_Green=1) and
not (NS_Yellow=1 and NS_Green=1)

In some embodiments, a constraint may be constructed based on the sum type EW_T, and may be similar to any one of the illustrative constraints described above in connection with the sum type NS_T. Since the input env may be associated with the sum types NS_T and EW_T via the Data domain, both a constraint for the sum type NS_T and a constraint for the sum type EW_T may be provided for the input env, for example, as follows.

```
Illustrative Constraint (2)
( (env_NS_Red=1 and env_NS_Yellow=0 and env_NS_Green=0) or
  (env_NS_Red=0 and env_NS_Yellow=1 and env_NS_Green=0) or
  (env_NS_Red=0 and env_NS_Yellow=0 and env_NS_Green=1) or
  (env_NS_Red=0 and env_NS_Yellow=0 and env_NS_Green=0) ) and
( (env_EW_Red=1 and env_EW_Yellow=0 and env_EW_Green=0) or
  (env_EW_Red=0 and env_EW_Yellow=1 and env_EW_Green=0) or
  (env_EW_Red=0 and env_EW_Yellow=0 and env_EW_Green=1) or
  (env_EW_Red=0 and env_EW_Yellow=0 and env_EW_Green=0) )
```

In some embodiments, a constraint may be constructed based on the sum type Transition_T, and may be similar to any one of the illustrative constraints described above in connection with the sum type NS_T (albeit with six, instead of three, variables). Since the input code may be associated with the type Transition_T via the Instruction domain, a constraint for the sum type Transition_T may be provided for the input code, for example, as follows.

```
Illustrative Constraint (3)
      (code_GoRedNS=1 and code_GoYellowNS=0 and code_GoGreenNS=0 and
code_GoRedEW=0 and code_GoYellowEW=0 and code_GoGreenEW=0) or
      (code_GoRedNS=0 and code_GoYellowNS=1 and code_GoGreenNS=0 and
code_GoRedEW=0 and code_GoYellowEW=0 and code_GoGreenEW=0) or
      (code_GoRedNS=0 and code_GoYellowNS=0 and code_GoGreenNS=1 and
code_GoRedEW=0 and code_GoYellowEW=0 and code_GoGreenEW=0) or
      (code_GoRedNS=0 and code_GoYellowNS=0 and code_GoGreenNS=0 and
code_GoRedEW=1 and code_GoYellowEW=0 and code_GoGreenEW=0) or
      (code_GoRedNS=0 and code_GoYellowNS=0 and code_GoGreenNS=0 and
code_GoRedEW=0 and code_GoYellowEW=1 and code_GoGreenEW=0) or
      (code_GoRedNS=0 and code_GoYellowNS=0 and code_GoGreenNS=0 and
code_GoRedEW=0 and code_GoYellowEW=0 and code_GoGreenEW=1) or
      (code_GoRedNS=0 and code_GoYellowNS=0 and code_GoGreenNS=0 and
code_GoRedEW=0 and code_GoYellowEW=0 and code_GoGreenEW=0)
```

In some embodiments, a constraint may be constructed based on a domain. As an example, the state metadata symbols NS_Red, NS_Yellow, NS_Green, EW_Red, EW_Yellow, and EW_Green may be associated with the Data domain (via the types NS_T and EW_T). The following constraint may be constructed for the Data domain: p₀=O and . . . and p_{N-1}=0, where p₀, . . . , p_{N-1} are all metadata symbols not associated with the Data domain (e.g., the transition metadata symbols GoRedNS, GoYellowNS, GoGreenNS, GoRedEW, GoYellowEW, and GoGreenEW, and/or one or more metadata symbols of one or more other domains).

Since the input env may be associated with the Data domain, a constraint based on the Data domain may be provided for the input env, for example, as follows.

```
      Illustrative Constraint (4)
      env_GoRedNS=0 and env_GoYellowNS=0 and env_GoGreenNS=0
and env_GoRedEW=0 and env_GoYellowEW=0 and env_GoGreenEW=0
```

As another example, the transition metadata symbols GoRedNS, GoYellowNS, GoGreenNS, GoRedEW, GoYellowEW, and GoGreenEW may be associated with the Instruction domain (via the type Transition_T). The following constraint may be constructed for the Instruction domain: q₀=0 and . . . and q_{M-1}=0, where q₀, . . . , q_{M-1} are all metadata symbols not associated with the instruction domain (e.g., the state metadata symbols NS_Red, NS_Yellow, NS_Green, EW_Red, EW_Yellow, and EW_Green, and/or one or more metadata symbols of one or more other domains).

Since the input code may be associated with the Instruction domain, a constraint based on the instruction domain may be provided for the input code, for example, as follows.

```
      Illustrative Constraint (5)
      code_NS_Red=0 and code_NS_Yellow=0 and code_NS_Green=0
and code_EW_Red=0 and code_EW_Yellow=0 and code_EW_Green=0
```

Returning to act 405 in the example of FIG. 4, one or more constraints R₀, R₁, . . . may be provided using any one or more of the illustrative techniques described above. For example, the one or more constraints R₀, R₁, . . . may include one or more of the illustrative constraints (1)-(5).

The inventors have recognized and appreciated that the following formula may be logically equivalent to a negation of a conjunction of the one or more constraints R₀, R₁,
(not R₀) or (not R₁) or . . .

Thus, a counterexample to the above logical formula (i.e., an assignment of truth values to the Boolean variables that makes the above logical formula false) may provide an assignment of truth values to the Boolean variables that satisfies all of the constraints R₀, R₁, . . . .

Accordingly, at act 410 in the example of FIG. 4, the one or more constraints R₀, R₁, . . . may be negated, thereby obtaining (not R₀), (not R₁), . . . Then, at act 415, a Boolean satisfiability solver may be used to solve for a counterexample to (not R₀) or (not R₁) or

The inventors have further recognized and appreciated that an assignment of truth values to the Boolean variables that satisfies all of the constraints R₀, R₁, . . . may correspond to an input pattern that may trigger the policy rule “rule 1” in the signalsafety policy.

Accordingly, if it is determined at act 420 that a counterexample c to (not R₀) or (not R₁) or . . . is found, an input pattern determined from such a counterexample may be recorded for the policy rule “rule_1” in the signalsafety policy. Additionally, or alternatively, c may be added at act 425 as a new negated constraint, and the process 400 may return to act 415 to solve for a counterexample to the following formula.
(not R₀) or (not R₁) or . . . or C

In this manner, any new counterexample identified may satisfy all of the constraints R₀, R₁, . . . , but may be different from the counterexample c. This may be repeated until no new counterexample is identified, which may result in a set of one or more input patterns, where each input pattern may trigger the policy rule “rule_1” in the signalsafety policy.

In some embodiments, the process 400 may be performed for each symbolic rule in the signalsafety policy to obtain a respective set of one or more input patterns. An input pattern in any of such sets may be installed into the rule table 144 for efficient access at run time.

It should be appreciated that aspects of the present disclosure are not limited to identifying input patterns in any particular manner. For instance, in some embodiments, the one or more constraints R₀, R₁, . . . may be combined via a conjunction, which may in turn be converted into disjunctive normal form. The inventors have recognized and appreciated that each disjunct in a logical formula in disjunctive normal form may correspond to a partial assignment of truth values, and one or more full assignments may be constructed that are consistent with the partial assignment (e.g., by assigning 0 or 1 to each Boolean variable not appearing in the disjunct). The one or more full assignments may then be used to obtain one or more input patterns be installed into the rule table 144 for efficient access at run time.

As discussed above, run time performance may, in some instances, not be of concern for disallowed instructions. Accordingly, in some embodiments, input patterns corresponding to disallowed instructions may not be computed ahead of time. Instead, such input patterns may be evaluated at run time (e.g., by invoking the illustrative policy processor in the example of FIG. 1). However, it should be appreciated that aspects of the present disclosure are not so limited. In some embodiments, a symbolic rule may be provided that may be matched by an input pattern corresponding to one or more disallowed instructions. Such a rule may map the input pattern to an error message that may be used for debugging and/or run time diagnostic purposes.

As an example, the illustrative signalSafety policy may, in some embodiments, include one or more policy rules corresponding to disallowed transitions of the FSM 300 in the example of FIG. 3, in addition to, or instead of, one or more policy rules corresponding to allowed transitions of the FSM 300. For instance, one or more of the following policy rules may be included, in addition to, or instead of, one or more of the seven illustrative policy rules above.

```
    ...
    \hat{ } rule_8 (code == [+GoGreenNS], env == [+EW_Green] −>
                fail “Safety Violation − East−West Lights Still Green”)
    \hat{ } rule_9 (code == [+GoGreenNS], env == [+EW_Yellow] −>
                fail “Safety Violation − East−West Lights Still Yellow”)
    \hat{ } rule_10 (code == [+GoYellowNS], env == [+EW_Green] −>
                fail “Safety Violation − East−West Lights Still Green”)
    \hat{ } rule_11 (code == [+GoYellowNS], env == [+EW_Yellow] −>
                fail “Safety Violation − East−West Lights Still Yellow”)
    \hat{ } rule_12 (code == [+GoGreenEW], env == [+NS_Green] −>
                fail “Safety Violation − North−South Lights Still Green”)
    \hat{ } rule_13 (code == [+GoGreenEW], env == [+NS_Yellow] −>
                fail “Safety Violation − North−South Lights Still
Yellow”)
    \hat{ } rule_14 (code == [+GoYellowEW], env == [+NS_Green] −>
                fail “Safety Violation − North−South Lights Still Green”)
    \hat{ } rule_15 (code == [+GoYellowEW], env == [+NS_Yellow] −>
                fail “Safety Violation − North−South Lights Still
Yellow”)
    \hat{ } rule_16 (code == _ , env == [NS_Yellow, EW_Green] −>
                fail “Safety Violation − Neither Set of Lights Is Red”)
    \hat{ } rule_17 (code == _ , env == [NS_Green, EW_Yellow] −>
                fail “Safety Violation − Neither Set of Lights Is Red”)
    \hat{ } rule_18 (code == _ , env == [NS_Green, EW_Green] −>
                fail “Safety Violation − Neither Set of Lights Is Red”)
    \hat{ } rule_19 (code == _ , env == [NS_Yellow, EW_Yellow] −>
                fail “Safety Violation − Neither Set of Lights Is Red”)
```

The additional policy rules may be described as follows.
8. The eighth policy rule may indicate that the north-south lights turning green from any state in which the east-west lights are green is a violation of the safety policy.
9. The ninth policy rule may indicate that the north-south lights turning green from any state in which the east-west lights are yellow is a violation of the safety policy.
10. The tenth policy rule may indicate that the north-south lights turning yellow from any state in which the east-west lights are green is a violation of the safety policy.
11. The eleventh policy rule may indicate that the north-south lights turning yellow from any state in which the east-west lights are yellow is a violation of the safety policy.
12. The twelfth policy rule may indicate that the east-west lights turning green from any state in which the north-south lights are green is a violation of the safety policy.
13. The thirteenth policy rule may indicate that the east-west lights turning green from any state in which the north-south lights are yellow is a violation of the safety policy.
14. The fourteenth policy rule may indicate that the east-west lights turning yellow from any state in which the north-south lights are green is a violation of the safety policy.
15. The fifteenth policy rule may indicate that the east-west lights turning yellow from any state in which the north-south lights are yellow is a violation of the safety policy.
16. The sixteenth policy rule may indicate that all instructions executing at a time when the north-south lights are yellow, and the east-west lights are green, is a violation of the safety policy.
17. The seventeenth policy rule may indicate that all instructions executing at a time when the north-south lights are green, and the east-west lights are yellow, is a violation of the safety policy.
18. The eighteenth policy rule may indicate that all instructions executing at a time when both the north-south lights and the east-west lights are green is a violation of the safety policy.
19. The nineteenth policy rule may indicate that all instructions executing at a time when both the north-south lights and the east-west lights are yellow is a violation of the safety policy.

The inventors have recognized and appreciated that, in some instances, it may be advantageous to explicitly model a disallowed transition in an FSM via a policy rule. For instance, the tag processing hardware 140 may issue an appropriate error message (e.g., “East-West Lights Still Green”) when a policy rule corresponding to a disallowed transition is matched. In some embodiments, such an error message may be consumed by a debugging tool (e.g., the illustrative debugger 230 in the example of FIG. 2).

A disallowed transition that triggers a policy rule may be referred to herein as an “explicitly” disallowed transition. A disallowed transition that does not trigger any policy rule may be referred to herein as an “implicitly” disallowed transition.

In some embodiments, the illustrative process 400 in the example of FIG. 4 (or some other suitable process for identifying input patterns) may be performed for each of the above symbolic rules to obtain a respective set of one or more input patterns corresponding to explicitly disallowed transitions. An input pattern in any of such sets may be installed into the rule table 144 for efficient access at run time, in addition to, or instead of, one or more input patterns corresponding to allowed transitions.

In some embodiments, the rule table 144 may map one or more input patterns corresponding to disallowed transitions to a failure identifier. In response to the rule table mapping an input pattern for an instruction to the failure identifier, the tag processing hardware 140 may log a corresponding error message. If the tag processing hardware 140 is operating in a logging mode, the tag processing hardware 140 may allow the instruction despite the error message. Otherwise, the tag processing hardware 140 may trigger policy violation processing.

In some embodiments, a concrete rule may include one or more input metadata labels and/or one or more output metadata labels. For instance, with reference to the policy rule “rule_self” in the illustrative signalSafety policy in the example of FIG. 3, the following concrete rule may include a first input metadata label { }(the empty set) in the first slot, a second input metadata label {NS_Red, EW_Red} in the second slot, and an output metadata label {NS_Red, EW_Red} in the third slot.

In some embodiments, one or more metadata labels of a concrete rule may be resolved into one or more respective binary representations. Installing the concrete rule into the rule table 144 may include using the one or more binary representations to create a rule entry. To check if an input pattern matches any concrete rule stored in the rule table 144, one or more metadata labels in the input pattern may be used to perform a lookup in the rule table 144. The one or more metadata labels may be retrieved from a metadata storage (e.g., the illustrative metadata memory 125 and/or the tag register file 146 in the example of FIG. 1), and may be represented by one or more respective binary representations.

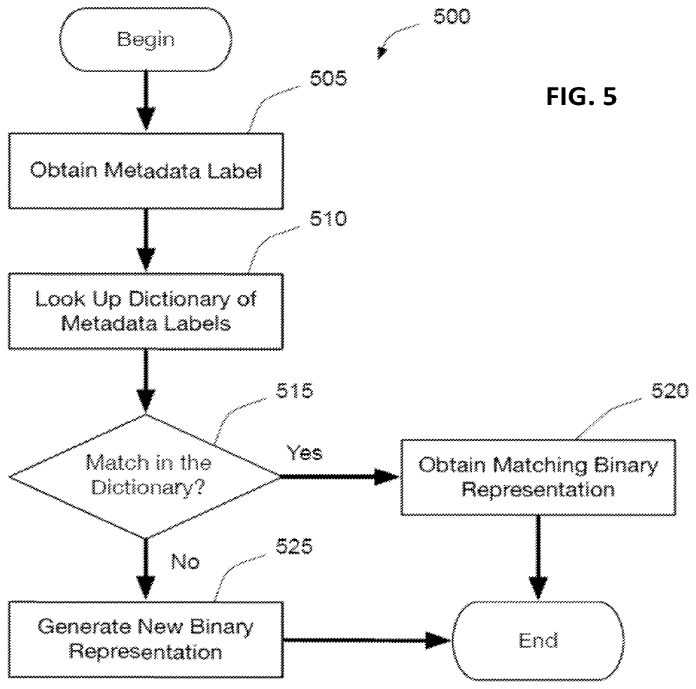

FIG. 5 shows an illustrative process 500 for resolving a metadata label into a binary representation, in accordance with some embodiments. The process 500 may be performed at any suitable time, such as compile time, link time, load time, and/or run time. For instance, part or all of the process 500 may be performed by the illustrative policy compiler 220, the illustrative policy linker 225, and/or the illustrative loader 215 in the example of FIG. 2. Additionally, or alternatively, the illustrative policy processor 150 may be programmed to perform part or all of the process 500 at run time.

At act 505, a metadata label may be obtained. For instance, a metadata label (e.g., represented by a list of one or more metadata symbols) may be received as input. Additionally, or alternatively, a list may be dynamically allocated to represent a metadata label. One or more metadata symbols may be added to the list incrementally, for example, as one or more policies are evaluated that reference the one or more metadata symbols.

In some embodiments, the list may be sorted according to a suitable ordering of metadata symbols, so that a same list may result regardless of an order in which the one or more metadata symbols are received and/or added. Below is an example of an ordering of metadata symbols for the illustrative signalSafety policy described in connection with the example of FIG. 3.
NS_Red, NS_Yellow, NS_Green, EW_Red, EW_Yellow, EW_Green,
GoRedNS, GoYellowNS, GoGreenNS, GoRedEW, GoYellowEW, GoGreenEW

At act 510, the metadata label obtained at act 505 (e.g., the list of one or more metadata symbols) may be used to look up a dictionary that maps metadata labels to corresponding binary representations. For instance, at run time, such a dictionary may be maintained by the tag processing hardware 140 and/or the policy processor 150. Additionally, or alternatively, at compile time, link time, or load time, such a dictionary may be maintained by the policy compiler 220, the policy linker 225, or the loader 215, respectively.

In some embodiments, the dictionary may be implemented using a hash table. Thus, a suitable hash function may be applied to the list representing the metadata label, and a resulting hash may be used to look up the hash table.

At act 515, it may be determined whether the metadata label matches an entry in the dictionary. If it is determined that there is a match, a matching binary representation may be obtained at act 520. Otherwise, a new binary representation may be generated at act 525.

For instance, if the hash of the list representing the metadata label maps to a non-empty bucket in the hash table implementing the dictionary, the list may be compared against one or more entries in the bucket to determine if there is a match. If there is a match, a binary representation of the matching entry may be used. Otherwise, a new binary representation may be generated. For instance, a counter may be maintained that counts a number of binary representations that have been used so far. This counter may be incremented each time a new binary representation is requested, and a binary string representing a value of the counter may be used as the new binary representation.

In some embodiments, the binary representation generated at act 525 may be added to the dictionary, so that the binary representation will be available if the same metadata label is encountered again in the future.

It should be appreciated that aspects of the present disclosure are not limited to resolving a metadata label into a binary representation in any particular manner, or at all. For instance, in some embodiments, a dictionary may be implemented using a graph, in addition to, or instead of a hash table. Various illustrative techniques for resolving metadata labels into binary representations are described in International Application No. PCT/US2020/059057, filed on Nov. 5, 2020, entitled “SYSTEMS AND METHODS FOR IMPROVING EFFICIENCY OF METADATA PROCESSING,” which is hereby incorporated by reference in its entirety.

The inventors have recognized and appreciated that obtaining a binary representation at run time or load time by hashing or graph traversal may cause an undesirable delay.

Moreover, hashing may consume additional processor cycles (and hence power), while storing a graph of binary representations may consume additional memory. Accordingly, in some embodiments, the illustrative policy compiler 220 and/or the illustrative policy linker in the example of FIG. 2 may resolve one or more metadata labels in a concrete rule into one or more respective binary representations. The concrete rule may be provided in binary form (e.g., with the one or more respective binary representations substituted for the one or more metadata labels) to the illustrative loader 215, for instance, as part of an initialization specification. The loader 215 may load the concrete rule in binary form into the illustrative rule table 144 in the example of FIG. 1. In this manner, computation may be shifted from run time and/or load time to compile time and/or link time, which may improve performance and/or reduce memory overhead for run time and/or load time.

As described above in connection with the example of FIG. 1, the rule table 144 may be implemented using a hash function and a selected memory, such as an on-chip random access memory (RAM). For instance, a rule entry may include an input pattern in binary form (e.g., with one or more respective binary representations substituted for one or more input metadata labels). Additionally, or alternatively, the rule entry may include an output pattern in binary form (e.g., with one or more respective binary representations substituted for one or more output metadata labels). A hash function may be applied to the input pattern in binary form to generate an address in the selected memory. The rule entry may be stored at that address in the selected memory.

The inventors have recognized and appreciated that a rule collision may occur in such an implementation. For instance, a rule entry having a first input pattern may be installed into the rule table 144. Subsequently, the rule table 144 may be queried with a second input pattern, which may be different from the first input pattern, but may hash to a same address. The rule table 144 may retrieve the rule entry from the selected memory, only to determine that the second input pattern does not match the first input pattern stored in the retrieved rule entry. Thus, the retrieved rule entry may be inapplicable, and the illustrative policy processor in the example of FIG. 1 may be queried with the second input pattern.

The inventors have recognized and appreciated that rule collisions may result in a performance degradation, especially if multiple collisions happen in close succession. For example, two concrete rules that are triggered frequently may happen to have input patterns that hash to a same address. This may cause thrashing, where the two rules may alternately cause each other to be evicted from the rule table 144, even if other addresses in the rule table may still be available to store concrete rules.

Moreover, the inventors have recognized and appreciated that implementing a rule table in hardware may be costly in terms of chip area. For instance, an input pattern may be stored for each concrete rule installed into the rule table, which may use a significant amount of RAM. As a result, more chip area may be used to provide the RAM.

Accordingly, in some embodiments, techniques are provided for determining, based on an input pattern in binary form, whether an instruction giving rise to the input pattern is allowed, without using a rule table.

The inventors have recognized and appreciated that a rule table may be viewed as a hardware implementation of a function that maps input patterns in binary form to one or more results, such as the following: (i) the instruction is disallowed without any error message, (ii) the instruction is disallowed with one or more error messages, (iii) the instruction is allowed without any output metadata label, and/or (iv) the instruction is allowed with one or more output metadata labels. Such a function may be referred to herein as a “policy check function.”

Indeed, a rule table may implement a policy check function by storing input patterns and corresponding results as ordered pairs (both in binary form), so that an application of the policy check function may involve looking up an input pattern in the set of ordered pairs stored in the rule table.

The inventors have recognized and appreciated that such a storage-and-lookup approach may be inefficient in terms of power consumption, performance, and/or chip area. For example, consider the function f(x)=2*x. This function may be implemented in hardware by storing the following ordered pairs in a cache (where all values are in binary form).

| Input x | Output f(x) = 2*x |
|---|---|
| 0 | 0 |
| 1 | 10 |
| 10 | 100 |
| 11 | 110 |
| 100 | 1000 |
| Etc. | Etc. |

In some implementations, each cache lookup may involve computing a hash of an input value x, using the hash to locate an entry in a cache memory, and determining if the input value x matches the located entry. That may lead to increased power consumption and/or decreased performance. Moreover, if a number of possible input values is large, a significant amount of chip area may be used to store all possible ordered pairs. To reduce chip area, only some (but not all) possible ordered pairs may be stored in the cache. However, as a result, a miss may occur, namely, looking up an input value x that is not present in the cache. In response, a software function may be invoked to compute f(x). That may also lead to increased power consumption and/or decreased performance (e.g., due to overhead involved for exception processing, context switching, etc.).

By contrast, it may be much more efficient to implement the function f(x)=2*x in hardware, for example, with an FPGA or fabricated logic configured to compute f(x) (e.g., by performing a left shift on an input value x, with or without handling any most significant bit being shifted off). In this manner, no cache lookup (and hence no hashing) may be performed, which may decrease power consumption and/or increase performance. Furthermore, ordered pairs are no longer stored, and therefore chip area may be significantly reduced. Further still, miss processing may not be performed, which may also decrease power consumption and/or increase performance.

Thus, the inventors have recognized and appreciated that it may be desirable to implement a policy check function in hardware, for example, with an FPGA or fabricated logic configured to compute a result from an input pattern in binary form. This may allow a rule table to be eliminated, or significantly reduced in size.

However, the inventors have also recognized and appreciated that different policy check functions may arise depending on which one or more policies are being enforced. Therefore, it may be desirable to provide processing hardware that is programmable to compute different policy check functions.

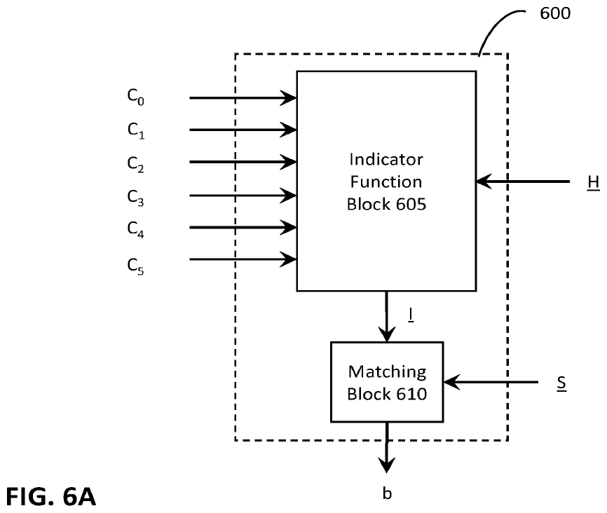

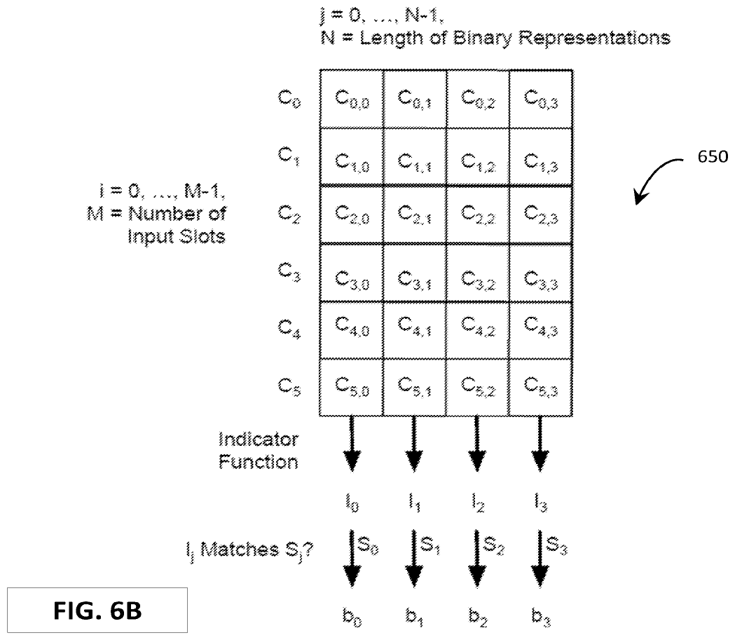

FIG. 6A shows an illustrative hardware block 600 implementing a policy check function, in accordance with some embodiments. In this example, there are six input slots, and there is no output slot. Accordingly, an input pattern may include up to six metadata labels, one for each input slot. A result may include one bit indicating whether an instruction giving rise to the input pattern is allowed.

Thus, the policy check function may map a sextuple of bit strings, <C₀, . . . , C₅>, to a single bit, b. Each bit string Cᵢ(i=0, . . . , 5) may be a binary representation of a metadata label Lᵢ for a corresponding input slot. The bit b may indicate whether an instruction giving rise to the input pattern, <L₀, . . . , L₅>, is allowed.

In the example of FIG. 6A, the hardware block 600 includes an indicator function block 605 and a matching block 610. The indicator function block 605 may be configured to process the input bit strings C₀, . . . , C₅, and output an indicator I. An illustrative implementation of the indicator function block 605 is described below in connection with the example of FIG. 6B.

In some embodiments, the matching block 610 may be configured to determine if the indicator I matches a parameter S. For instance, the matching block 610 may be configured to check if the indicator I equals the parameter S. However, it should be appreciated that aspects of the present disclosure are not limited to checking for equality. For instance, in some embodiments, the matching block 610 may be configured to perform one or more other comparison operations (e.g., greater than or less than) to the indicator I and the parameter S.

In some embodiments, the parameter S may be chosen based on one or more policies being enforced, and may be updated dynamically. By contrast, in some embodiments, the indicator function block 605 and/or the matching block 610 may be used regardless of which one or more policies are being enforced. For instance, the indicator function block 605 may be implemented via an FPGA or fabricated logic (or otherwise in hardware), and likewise for the matching block 610.

However, it should be appreciated that aspects of the present disclosure are not limited to choosing the parameter S in any particular manner, or having a parameter S at all. In some embodiments, the matching block 610 may have no parameter. For instance, the matching block 610 may be configured to perform one or more unary operations (e.g., a parity check) on an indicator I.

FIG. 6B shows an illustrative array 650 of bits, in accordance with some embodiments. The array 650 has M rows and N columns, where M is a number of input slot(s), and N is a length of binary representation(s). In this example, there are six input slots (i.e., M=6), and hence there are six rows. These rows may correspond, respectively, to the bit strings C₀, . . . , C₅ in the example of FIG. 6A.

Moreover, in the example of FIG. 6B, each bit string Cᵢ is 4-bit long (i.e., N=4), and hence there are four columns. Such columns may be referred to herein as “bit lanes.”

In some embodiments, a policy check function may compute, for each bit lane j in the array 650, an indicator Iⱼ. The indicator Iⱼ may be compared against a parameter Sⱼ of the policy check function (e.g., at the illustrative matching block 610 in the example of FIG. 6A). If the indicator Iⱼ matches the corresponding parameter Sⱼ for every j=0, . . . , N−1, then the policy check function may return b=1, indicating that the instruction giving rise to the input pattern, <L₀, . . . , L₅>, is allowed. If the indicator Iⱼ does not match the corresponding parameter Sⱼ for any j=0, . . . , N−1, then the policy check function may return b=0, indicating that the instruction giving rise to the input pattern, <L₀, . . . , L₅>, is disallowed.

Given any bit lane j=0, . . . , N−1, an indicator Iⱼ may have any suitable number of one or more bits, and likewise for a parameter Sⱼ. The number of bit(s) in the indicator Iⱼ may be the same as, or different from, the number of bit(s) in the parameter Sⱼ.

In some embodiments, an indicator function Ind may be used to compute the indicator Iⱼ for each bit lane j in the array 650. For example, Iⱼ may be computed as Ind(C_{0,j}: . . . : C_{5,j}), where: denotes concatenation of bits to form a bit string. The inventors have recognized and appreciated that, if the indicator function Ind may be readily computed in hardware, then the resulting policy check function may also be readily computed in hardware.

For instance, given a hardware block implementing the indicator function Ind, the resulting policy check function may be implemented by: (i) duplicating the hardware block N times (if N>1), once for each bit lane j; (ii) comparing an indicator output Iⱼ in each bit lane j against the corresponding parameter Sⱼ; and (iii) combining resulting bits b₀, . . . , b_{N-1} with an AND operator.

An indicator output Iⱼ in a bit lane j may be compared against a corresponding parameter S₁ in any suitable manner. In some embodiments, S₁ may be a bit string of all zero(s). Accordingly, one or more bits of the indicator output Iⱼ may be combined with an OR operator to determine if each of the one or more bits is 0. Additionally, or alternatively, Sⱼ may be a bit string of all one(s). Accordingly, one or more bits of the indicator output Iⱼ may be combined with an AND operator to determine if each of the one or more bits is 1.

Additionally, or alternatively, the parameter Sⱼ may be stored in a first register, and the indicator output Iⱼ may be stored in a second register. An equality test circuit may be used to determine if the contents of these registers are equal.

The inventors have recognized and appreciated that an indicator function Ind may partition the set of bit strings of length M (in this example, M=6) into a plurality of subsets. For instance, given an indicator value S, there may be a subset of zero or more bit strings X of length 6 such that Ind(X)=S.

Accordingly, the indicator function Ind may induce a partition of the set of N-tuples of bit strings of length M (in this example, N=4 and M=6). For instance, given a quadruple <S₀, . . . , S₃> of indicator values, there may be a subset of quadruples <X₀, . . . , X₃> of bit strings of length 6 such that Ind(Xⱼ)=Sⱼ, for each j=0, . . . , 3. (The function that maps <X₀, . . . , X_{N-1}> to <Ind(X₀), . . . , Ind(X_{N-1})> may be written herein as Ind^{N}.)

Furthermore, the inventors have recognized and appreciated that there may be a one-to-one correspondence (e.g., via transposition) between the set of N-tuples of bit strings of length M and the set of M-tuples of bit strings of length N. Therefore, the indicator function Ind may induce a partition of the set of M-tuples of bit strings of length N. For instance, given an N-tuple S=S₀, . . . , S_{N-1}> of indicator value(s), there may be a subset of zero or more M-tuples <C₀, . . . , C_{M-1}> of bit string(s) of length N such that:
Ind^{N} (C₀, . . . , C_{M-1})=<Ind(C_{0,0}: . . . : C_{M-1,0}), . . . , Ind(C_{0,N-1}: . . . : C_{M-1,N-1})>=<S₀, . . . , S_{N-1}>.

Such a subset may be referred to herein as a “pre-image” of S under the function Ind^{N}. Thus, the policy check function described above, parameterized by S, may simply be a membership check for the pre-image of S under the function Ind^{N}.

However, it should be appreciated that aspects of the present disclosure are not limited to checking that an indicator output Iⱼ matches the corresponding parameter S₁ for every bit lane j. In some embodiments, the illustrative matching block 610 in the example of FIG. 6A may compare the indicator output Iⱼ against the corresponding parameter Sⱼ in each bit lane j, and then combine the resulting bits b₀, . . . , b_{N-1} using any suitable logical circuit, in addition to, or instead of, an AND operator.

For instance, the matching block 610 may be programmable to implement any logical formula F. In that respect, any logical formula F may be written in disjunctive normal form, F₀∨ . . . ∨F_{A}, where each Fₐ may be a conjunction of one or more of the bits b₀, . . . , b_{N-1}, ¬b₀, . . . , ¬b_{N-1} (where ¬ denotes negation). The matching block 610 may be programmed to implement the formula F by: (i) for each j, applying an inverter to bⱼ to obtain ¬bⱼ; (ii) for each Fₐ, applying an AND operator to the corresponding one or more of the bits b₀, . . . , b_{N-1}, ¬b₀, . . . , ¬b_{N-1}; and (iii) applying an OR operator to F₀, . . . , F_{A}.

The inventors have recognized and appreciated that a logical formula F may correspond to a subset of M-tuples of bit strings of length N. For instance, for any given bit lane j, bⱼ may correspond to the preimage of the parameter Sⱼ under the indicator function Ind (or Indⱼ, if different indicator functions are used for the different bit lanes, as described below), and ¬bⱼ may correspond to the complement of that preimage. Furthermore, each Fₐ may correspond to an intersection of one or more such preimages and/or complements thereof, and F may correspond to a union of such intersections.

In this manner, the policy check function may be a membership check for the subset of M-tuples of bit strings of length N corresponding to the logical formula F implemented by the matching block 610. In some embodiments, the logical formula F may be treated as a parameter of the policy check function, although aspects of the present disclosure are not so limited.

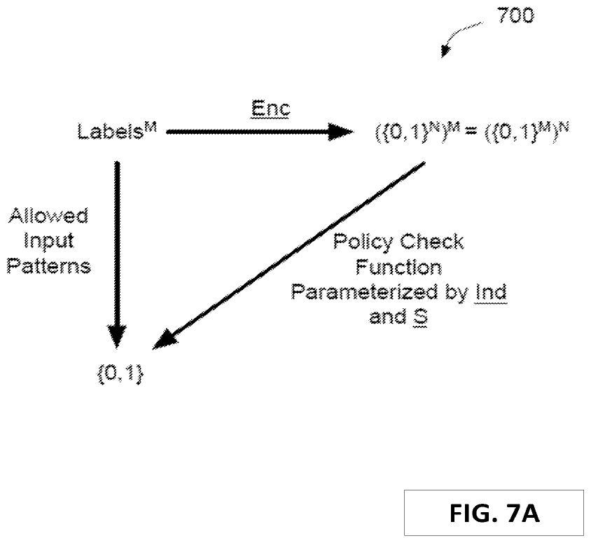

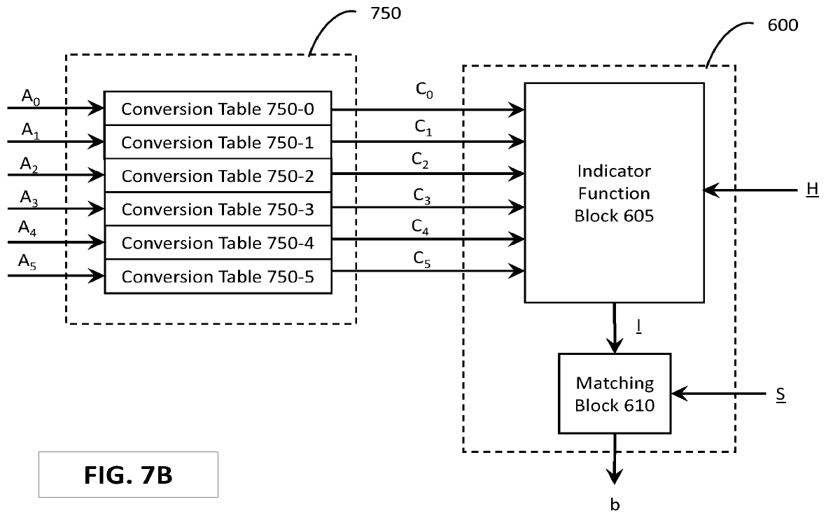

FIG. 7A shows an illustrative arrangement 700 of functions, in accordance with some embodiments. In this example, Labels denotes a set of metadata labels, and Labels^{M} denotes a set of input patterns, where each input pattern includes an M-tuple <L₀, . . . , L_{M-1}> of metadata labels (M>=1). The arrow from Labels^{M} to {0,1} may denote a function that maps an input pattern to a bit b indicating whether an instruction giving rise to the input pattern is allowed. Such a function may be determined based on one or more policies to be enforced. For instance, one or more of the illustrative techniques described in connection with the example of FIG. 4 may be used to identify one or more input patterns that are mapped to 1 (indicating allowed).

In the example of FIG. 7A, Enc denotes an encode function that maps a metadata label L to a corresponding binary representation C (e.g., a bit string of length N, N>=1), and Enc denotes a function that maps an M-tuple <L₀, . . . , L_{M-1}> of metadata label(s) to an M-tuple <C₀, . . . , C_{M-1}> of corresponding binary representation(s), where Cᵢ=Enc(Lᵢ) (i=0, . . . , M−1). Thus, in this example, Enc=Enc^{M}.

The inventors have recognized and appreciated that, if an encode function Enc may be selected such that all allowed input patterns are mapped by Enc^{M} into a pre-image of a single N-tuple S=S₀, . . . , S_{N-1}> of indicator value(s), then a policy check function parameterized by S may provide correct answers for all binary representations of allowed input patterns. Indeed, given an input pattern <L₀, . . . , L_{M-1}> that is mapped to 1 (indicating allowed), if the corresponding binary representation(s) <C₀, . . . , C_{M-1}> is in the pre-image of S, then the policy check function parameterized by S may map <C₀, . . . , C_{M-1}> to 1 (indicating allowed). This is because, as discussed above, the policy check function parameterized by a may simply be a membership check for the pre-image of S.

Accordingly, in some embodiments, techniques are provided for selecting an encode function Enc and/or an N-tuple S=S₀, . . . , S_{N-1}> of indicator value(s) such that all allowed input patterns are mapped by Enc^{M} into a pre-image of S under a suitable function Ind. For instance, Ind may be Ind^{N}, for some suitable indicator function Ind.

In some embodiments, an indicator I may be a bit string i₀: . . . : i_{V-1} of length V for some suitable V>=1. Thus, an indicator function Ind may map a bit string X=x₀: . . . : x_{M-1} of length M to a bit string Ind(X)=i₀: . . . : i_{V-1} of length V. For instance, Ind(X) may be computed based on the following equation:

$${Ind ( X )}^{T} = H {X}^{T} ,$$

where the superscript T denotes matrix transpose (e.g., flipping a row vector into a column vector, or vice versa), and H is an V×M parity check matrix. Thus, in this example, Ind(X) may be a syndrome of X.

In some embodiments, the following parity check matrix H (where V=3 and M=6) may be used.

| | | | | | |
|---|---|---|---|---|---|
| 1 | 1 | 0 | 1 | 0 | 0 |
| 1 | 0 | 1 | 0 | 1 | 0 |
| 0 | 1 | 1 | 0 | 0 | 1 |

The inventors have recognized and appreciated that the indicator function Ind based on the parity check matrix H may be readily computed in hardware. For instance, matrix multiplication may be implemented in hardware by using an AND operator for multiplication and/or an XOR operator for addition. Thus, as discussed above, the resulting policy check function may also be readily computed in hardware.

In some embodiments, the parity check matrix H may be implemented using V register(s) (e.g., in the illustrative indicator function block 605 in the example of FIG. 6B), where each register may store M bit(s) (e.g., V=3 and M=6). Thus, the parity check matrix H may be programmed by modifying the bit string(s) of length M stored in the V register(s), and the corresponding indicator function Ind may be treated as a parameter of the policy check function.

However, it should be appreciated that aspects of the present disclosure are not limited to treating an indicator function as a parameter. For instance, the inventors have recognized and appreciated that setting aside registers for storing a parity check matrix may increase chip area. Accordingly, in some embodiments, a parity check matrix may be selected ahead of time, and may be fixed in hardware (e.g., in an FPGA or fabricated logic).

Although details of implementation are described above in connection with the examples of FIGS. 6A-B and 7A, it should be appreciated that aspects of the present disclosure are not limited to any particular manner of implementation. For instance, aspects of the present disclosure are not limited to using any particular parity check matrix, or any parity check matrix at all, to compute an indicator.

It should also be appreciated that aspects of the present disclosure are not limited to any particular number N of one or more bits in a binary representation of a metadata label, any particular number M of one or more input slots, or any particular number V of one or more bits in an indicator value.

It should also be appreciated that Ind^{N} may be viewed as a product Ind where all component(s) Indⱼ are identical, and Ind may be viewed as a product Ind with just one component. Each of these may be referred to herein as an indicator function, and may be treated as a parameter of a policy check function.

However, aspects of the present disclosure are not limited to using a common indicator function Ind for all bit lanes j=0, . . . , N−1 (where N>1). In some embodiments, different bit lanes j may have different indicator functions Indⱼ, and a product of such indicator functions, Ind=<Ind₀, . . . , Ind_{N-1}>, may be used. For instance, different matrices Hⱼ may be provided for different bit lanes j=0, . . . , N−1. Indⱼ(X) may be computed based on the following equation: Indⱼ(X)^{T}=Hⱼ X^{T}.

Furthermore, aspects of the present disclosure are not limited to computing a separate indicator for each bit lane j. In some embodiments, the policy check function may have a parameter S, and an indicator function Ind may map an M-tuple <C₀, . . . , C_{M-1}> of bit string(s) of length N to an indicator I, which may be compared against the parameter S. The parameter S may be a tuple of one or more values, and likewise for the indicator I. A length of the indicator I may be the same as, or different from, a length of the parameter S.

For instance, an indicator I may be computed by hashing one or more bits from the bit string(s) C₀, . . . , C_{M-1} to obtain a hash value, and using the hash value to look up a result bit b from a table. As an example, one or more of bitstrings Cᵢ(i=0, . . . , M−1) may be selected, and a substring C′ᵢ may be selected from each of the selected bitstring(s) Cᵢ. The selected substring(s) C′ᵢ may then be concatenated and/or hashed. The selected substring(s) C′ᵢ may be from the same bit position(s) (e.g., the least significant byte) of the selected bit string(s) Cᵢ, or from different bit position(s).

In some embodiments, given a hardware block implementing such an indicator function Ind (e.g., the illustrative indicator function block 605 in the example of FIG. 6A), a resulting policy check function may be implemented simply by adding a comparison circuit (e.g., in the illustrative matching block 610 in the example of FIG. 6A). The comparison circuit may implement an equality check, or some other suitable comparison, between a stored parameter S and an output I of the hardware block implementing the indicator function Ind.

Further still, aspects of the present disclosure are not limited to computing indicators for bit lanes. In some embodiments, one or more indicators may be computed for one or more input slots (e.g., one or more rows in the example of FIG. 6B), in addition to, or instead of, one or more bit lanes (e.g., one or more columns in the example of FIG. 6B).

It should also be appreciated that aspects of the present disclosure are not limited to mapping allowed input patterns into a single pre-image. In some embodiments, a policy check function may check if an input pattern belongs to one of multiple pre-images. For instance, a policy check function may have two parameters S and S′ (e.g., S=S₀, . . . , S_{N-1}> and S′=S′₀, . . . , S′_{N-1}>), and the policy check function may check if an input pattern belongs to a pre-image of S or a pre-image of S′.

It should also be appreciated that Enc^{M} may be viewed as a product Enc where all component(s) Encᵢ are identical, and Enc may be viewed as a product Enc with just one component. Each of these may be referred to herein as an encode function.

However, aspects of the present disclosure are not limited to using a common encode function Enc for all input slots (where M>1). In some embodiments, different input slots i may have different encode functions Encᵢ, and a product of such encode functions, Enc=<Enc₀, . . . , Enc_{M-1}>, may be used. For instance, if a metadata label L appears in an input slot i, an encoding of L for the input slot i may be Cᵢ=Encᵢ(L). If the same metadata label L also appears in a different input slot i′, an encoding of L for the input slot i′ may be Cᵢ′=Encᵢ′(L). Thus, the metadata label L may have a different encoding depending on an input slot in which the metadata label L appears.

The inventors have recognized and appreciated that having different encode functions for different input slots may increase degrees of freedom, which may in turn increase a likelihood that a suitable set of encodings for metadata labels may be found. However, it should be appreciated that aspects of the present disclosure are not so limited.

FIG. 7B shows an illustrative conversion block 750, in accordance with some embodiments. For instance, the conversion block 750 may be used to convert an M-tuple <A₀, . . . , A_{M-1}> of bit string(s) of length N′ to an M-tuple <C₀, . . . , C_{M-1}> of bit string(s) of length N, for some suitable M, N, N′>=1. The input M-tuple <A₀, . . . , A_{M-1}> may be a result of applying a suitable encode function Enc to an input pattern <L₀, . . . , L_{M-1}>. For instance, <A₀, . . . , A_{M-1}>=Enc^{M}<L₀, . . . , L_{M-1}>=<Enc(L₀), . . . , Enc(L_{M-1})>. The output M-tuple <C₀, . . . , C_{M-1}> may be provided as input to the illustrative hardware block 600 in the example of FIG. 6A.

In some embodiments, N may be strictly greater than N′, so that the conversion block may be an expansion block. In some other embodiments, N may be strictly less than N′, so that the conversion block 750 may be a compression block. In some other embodiments, N may be equal to N′.

In some embodiments, the conversion block 750 may include a storage (e.g., an on-chip RAM) having M conversion table(s). For instance, in the example of FIG. 7B, there are six conversion tables 750-0, . . . , 750-5. Given an input slot i, the encoding Aᵢ may be used to look up the conversion table 750-i to retrieve a corresponding Cᵢ. Therefore, in this example, Encᵢ may be Enc followed by a mapping implemented by the conversion table 750-i, for each i=0, . . . , M−1.

In an embodiment where N′ is strictly smaller than N, the mapping implemented by the table 750-i (i=0, . . . , M−1) may be viewed as an expansion function Expᵢ. Each such expansion function Expᵢ may have a corresponding compression function Compᵢ that maps a bit string of length N (e.g., Cᵢ) to a bit string of length N′ (e.g., Aᵢ).

It should be appreciated that aspects of the present disclosure are not limited to implementing a conversion table in any particular manner, or at all. In some embodiments, a conversion table 750-i may be populated before run time (e.g., at compile time, link time, and/or load time) by applying a corresponding compression function Compᵢ to binary representations of length N (e.g., Cᵢ) to obtain binary representations of length N′ (e.g., Aᵢ). A binary representation of length N′ may be used as an address from which a corresponding binary representation of length N may be retrieved.

Additionally, or alternatively, a hash function, or some other suitable function implemented in hardware, may be used to map a binary representation of length N′ to an address from which a corresponding binary representation of length N may be retrieved.

Additionally, or alternatively, a binary representation of length N′ may be used to look up an intermediate value from a conversion table 750-i. The intermediate value may in turn be used to compute (e.g., in hardware) a corresponding binary representation of length N.

It should also be appreciated that aspects of the present disclosure are not limited to having multiple conversion tables. In some embodiments, a common conversion table may be used for each i=0, . . . , M−1.

The inventors have recognized and appreciated that a Boolean satisfiability solver may be used to select an encode function Enc and a parameter S such that all allowed input patterns are mapped by Enc into a pre-image of S under some suitable indicator function Ind. For instance, the indicator function Ind may be the illustrative indicator function Ind^{N} described above in connection with the example of FIG. 7A, based on the illustrative parity check matrix H.

Referring again to the example of FIG. 6B, the Boolean satisfiability solver may, in some embodiments, be used to select a logical formula F, along with the encode function Enc and parameter S, such that all allowed input patterns are mapped by Enc into a union of intersection(s) of pre-image(s) and/or complement(s) thereof of Sⱼ under Ind (j=0, . . . , N−1).

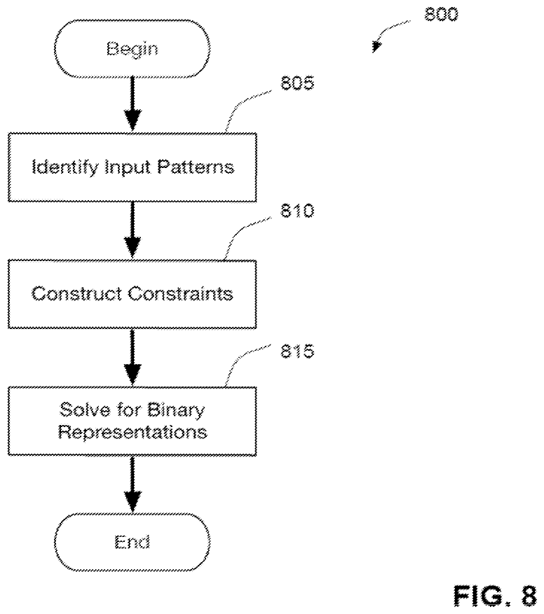

FIG. 8 shows an illustrative process 800 for selecting an encode function and a parameter, in accordance with some embodiments. Part or all of the process 800 may be performed at compile time, link time, and/or load time (e.g., by the illustrative policy compiler 220, the illustrative policy linker 225, and/or the illustrative loader 215 in the example of FIG. 2, respectively). Additionally, or alternatively, part or all of the process 800 may be performed at run time by the illustrative tag processing hardware 140 and/or the illustrative policy processor 150 in the example of FIG. 1. For instance, part or all of the process 800 may be performed when one or more policies being enforced are dynamically updated.

At act 805, some or all allowed input patterns may be identified. For instance, one or more of the illustrative techniques described in connection with the example of FIG. 4 may be used to identify one or more input patterns that trigger one or more symbolic rules in one or more policies to be enforced. Such input patterns may include one or more input patterns corresponding to allowed instructions and/or one or more input patterns corresponding to explicitly disallowed instructions.

As discussed above in connection with the example of FIG. 4, run time performance may not be of concern for disallowed instructions. Accordingly, in some embodiments, some or all input patterns corresponding to allowed instructions may be identified, whereas input patterns corresponding to explicitly disallowed instructions may not be included.

In some embodiments, all allowed input patterns may be identified, and a count of such input patterns may be obtained.

At act 810, one or more constraints may be constructed. Such a constraint may include a condition involving one or more variables. For instance, each metadata label L that appears in some input pattern identified at act 805 may be associated with M×N Boolean variable(s) c^{L}_{i,j}, where i=0, . . . , M−1, and j=0, . . . , N−1. If the metadata label L appears in input slot 0, then c^{L}_{0,0}, . . . , c^{L}_{i′,N-1} may be used to construct one or more constraints. Likewise, if the metadata label L appears in input slot 1, then c^{L}_{1,0}, . . . , c^{L}_{1,N-1} may be used to construct one or more constraints, and so on.

Thus, for an input pattern P=<L₀, . . . , L_{M-1}>, there may also be M×N Boolean variable(s): C^{L_i}_{i,j}, i=0, . . . , M−1, and j=0, . . . , N−1. For instance, if a metadata label L appears in two different input slots (e.g., i and i′), different Boolean variables may be used (e.g., c^{L}_{i,0}, . . . , c^{L}_{i,N-1} and c^{L}_{i′,0}, . . . , c^{L}_{i′,N-1}, respectively).

Additionally, or alternatively, there may be V×N variable(s) s_{i,j}, where i=0, . . . , V−1, and j=0, . . . , N−1.

In some embodiments, a constraint may be constructed for each input pattern identified at act 805. As an example, given an input pattern P=<L₀, . . . , L_{M-1}>, N constraints may be constructed as follows: for each j=0, . . . , N−1,

$$Ind 〈 {c}_{0 , j}^{L \_ 0} , … , {c}_{M - 1 , j}^{L \_ M - 1} 〉 = 〈 {s}_{0 , j} , … , {s}_{V - 1 , j} 〉 ,$$

where Ind is a suitable indicator function. Thus, for each j=0, . . . , N−1, the corresponding constraint may provide that an indicator computed from an assignment of the variable(s) c^{L_0}_{0,j}, . . . , c^{L_M-1}_{M-1,j} matches an assignment of the variable(s) s_{0,j}, . . . , s_{V-1,j}.

As described above, in some embodiments, an indicator function Ind may be provided based on a parity check matrix. For instance, for each j=0, . . . , N−1, the j-th constraint may be provided as follows:

$$H {〈 {c}_{0 , j}^{L \_ 0} , … , {c}_{M - 1 , j}^{L \_ M - 1} 〉}^{T} = {〈 {s}_{0 , j} , … , {s}_{V - 1 , j} 〉}^{T} ,$$

where the superscript T denotes matrix transpose (e.g., flipping a row vector into a column vector, or vice versa), and H is an V×M parity check matrix.

At act 815, a Boolean satisfiability solver may be used to solve for one or more of the Boolean variables subject to one or more of the constraints constructed at act 810. Any suitable Boolean satisfiability solver may be used, including, but not limited to, a satisfiability modulo theories (SMT) solver.

In some embodiments, a solution returned by the Boolean satisfiability solver may include, for each metadata label L that appears in some input pattern identified at act 805, and each i=0, . . . , M−1, an assignment of the variable(s) c^{L}_{i,0}, . . . , c^{L}_{i,N-1} to truth value(s). A bit string may be obtained by concatenation, and may be used as Encᵢ(L) for the metadata label L.

It should be appreciated that aspects of the present disclosure are not limited to having different encode functions Encᵢ for different input slots i. In some embodiments, a common encode function Enc may be used for all input slots. Thus, each metadata label L may be associated with N Boolean variable(s) c^{L}₀, . . . , c^{L}_{N-1}. For an input pattern P=<L₀, . . . , L_{M-1}>, there may be M×N Boolean variable(s): c^{L_i,j}, i=0, . . . , M−1, and j=0, . . . , N−1. For each j=0, . . . , N−1, the j-th constraint may be provided as follows:

$$Ind 〈 {c}_{j}^{L \_ 0} , … , {c}_{j}^{L \_ M - 1} 〉 = 〈 {s}_{0 , j} , … , {s}_{V - 1 , j} 〉 .$$

Accordingly, a solution returned by the Boolean satisfiability solver may include an assignment of the variable(s) c^{L}₀, . . . , c^{L}_{N-1} to truth value(s). A bit string may be obtained by concatenation, and may be used as Enc(L) for the metadata label L.

The inventors have recognized and appreciated that, by allowing different encode functions Encᵢ for different input slots i, more variables may be introduced (e.g., M×N variables c^{L}_{i,j} for each metadata label L, as opposed to just N variables c^{L}ⱼ). As a result, less restrictive constraints may be constructed at act 810, and a solution may be found more readily at act 815. However, as discussed above, aspects of the present disclosure are not limited to using different encode functions Encᵢ for different input slots i.

In some embodiments, a solution returned by the Boolean satisfiability solver may include, for each j=0, . . . , N−1, an assignment of the variable(s) s_{0,j}, . . . , s_{V-1,j} to truth value(s). A bit string may be obtained by concatenation, and may be used as Sⱼ of S=<S₀, . . . , S_{N-1}>.

It should be appreciated that aspects of the present disclosure are not limited to having a different Sⱼ for each bit lane j=0, . . . , N−1. In some embodiments, there may be only V variable(s) sᵢ, where i=0, . . . , V−1. For each j=0, . . . , N−1, the j-th constraint may be provided as follows:

$$Ind 〈 {c}_{0 , j}^{L \_ 0} , … , {c}_{M - 1 , j}^{L \_ M - 1} 〉 = 〈 {s}_{0} , … , {s}_{V - 1} 〉 .$$

Accordingly, a solution returned by the Boolean satisfiability solver may include an assignment of the variable(s) s₀, . . . , s_{V-1} to truth value(s). A bit string may be obtained by concatenation, and may be used as the parameter S.

Additionally, or alternatively, there may be 2×V×N variables s_{i,j} and s′_{i,j}, where i=0, . . . , V−1, and j=0, . . . , N−1. For each j=0, . . . , N−1, the j-th constraint may be provided as follows:

$$( Ind 〈 {c}_{0 , j}^{L \_ 0} , … , {c}_{M - 1 , j}^{L \_ M - 1} 〉 = 〈 {s}_{0} , … , {s}_{V - 1} 〉 ) or \\ ( Ind 〈 {c}_{0 , j}^{L \_ 0} , … , {c}_{M - 1 , j}^{L \_ M - 1} 〉 = 〈 {s}_{0}^{′} , … , {s}_{V - 1}^{′} 〉 ) .$$

Accordingly, a solution returned by the solver may include, for each j=0, . . . , N−1, an assignment of the variable(s) s_{0,j}, . . . , s_{V-1,j} to truth value(s), as well as an assignment of the variable(s) s′_{0,3}, . . . , s′_{V-1, j} to truth value(s). A bit string may be obtained by concatenation from the assignment of s_{0,j}, . . . , s_{V-1,j}, and may be used as Sⱼ of S=S₀, . . . , S_{N-1}>. Likewise, a bit string may be obtained by concatenation from the assignment of s′_{0,j}, . . . , s′_{V-1,j} and may be used as S′ⱼ of S′=S′₀, . . . , S′_{N-1}>.

The inventors have recognized and appreciated that more variables (e.g., 2×V×N variables s_{i,j} and s′_{i,j}, or V×N variables s_{i,j}, as opposed to just V variables sᵢ) may result in less restrictive constraints at act 810, so that a solution may be found more readily at act 815. However, it should be appreciated that aspects of the present disclosure are not limited to using any particular number of variables.

For instance, in some embodiments, the process 800 may be repeated with different values of N (i.e., different lengths for binary representations of metadata labels). As an example, a small N (e.g., N=1, 2, 3, 4, 5, . . . ) may be used initially. If the Boolean satisfiability solver is unable to find a solution, N may be increased (e.g., by 1, 2, . . . ). With each such increase, more variables may be introduced, which may result in less restrictive constraints. This may be repeated until the Boolean satisfiability solver is able to find a solution.

Although details of implementation are described above in connection with the example of FIG. 8, it should be appreciated that aspects of the present disclosure are not limited to any particular manner of implementation. For instance, aspects of the present disclosure are not limited to using a Boolean satisfiability solver. In some embodiments, one or more exact and/or approximate optimization techniques may be used. For example, a heuristic technique such as simulated annealing may be used to select an encode function Enc and a parameter S so as to increase one or more scores.

Moreover, aspects of the present disclosure are not limited to using a Boolean satisfiability solver to select both an encode function Enc and a parameter S. In some embodiments, an encode function may be selected in another suitable manner, and a Boolean satisfiability solver may be used to select a parameter S, or vice versa. Additionally, or alternatively, a Boolean satisfiability solver may be used to select an indicator function, for instance, by selecting an V×M matrix Hⱼ for each bit lane j=0, . . . , N−1.

The inventors have recognized and appreciated that, although there may be M input slot(s), an input pattern may be encountered that has fewer than M metadata label(s). For instance, an input slot may be used to present a metadata label associated with a storage location (e.g., a register or a memory location) accessed by an instruction, but not every instruction may access a storage location.

Accordingly, in some embodiments, there may be M×N variable(s) t_{i,j}, where i=0, . . . , M−1, and j=0, . . . , N−1. If an input slot i is empty in an input pattern, the variable(s) t_{i, 0}, . . . , t_{i,N-1} may be used in constructing one or more constraints at act 810 in the example of FIG. 8.

Additionally, or alternatively, there may be N variable(s) tⱼ, where j=0, . . . , N−1. If any input slot is empty in an input pattern, the variable(s) t₀, . . . , t_{N-1} may be used in constructing one or more constraints at act 810 in the example of FIG. 8.

However, it should be appreciated that aspects of the present disclosure are not limited to having variables that represent an empty input slot. In some embodiments, a selected bit string (e.g., a bit string of N zeros) may be used to represent an empty input slot.

As discussed above, the illustrative constraints constructed at act 810 in the example of FIG. 8 may provide that, for each allowed input pattern P=<L₀, . . . , L_{M-1}>, an indicator computed from an assignment of the variable(s) c^{L_0}_{0,j}, . . . , c^{L_M-1}_{M-1,j} matches an assignment of the variable(s) s_{0,j}, . . . , s_{V-1,j} for bit lane j=0, . . . , N−1. Thus, a policy check function parameterized by Ind and S may provide correct answers for all binary representations of allowed input patterns. That is, given an allowed input pattern P, the policy check function parameterized by Ind and S may map Enc(P) to 1. As a result, the policy check function, when implemented by the illustrative tag processing hardware 140 in the example of FIG. 1, may allow every instruction that should be allowed according to one or more policies being enforced, and therefore may be thought of as a test with no false positive error (i.e., no allowed instruction being incorrectly flagged as a policy violation).

The inventors have recognized and appreciated that it may be desirable to prevent or reduce false negative errors (i.e., failing to flag disallowed instructions as policy violations), in addition to, or instead of, preventing or reducing false positive errors. For instance, it may be desirable to have a policy check function that disallows every instruction that should be disallowed. Stated differently, it may be desirable to have a policy check function that allows only those instructions that should be allowed.

Accordingly, in some embodiments, an evaluation function Eval may be provided based on one or more policies being enforced, such that, given an input pattern P=<L₀, . . . , L_{M-1}>, Eval(P)=1 if and only if an instruction giving rise to the input pattern P is allowed according to the one or more policies.

Accordingly, the following constraint may be provided at act 810 in the example of FIG. 8.

### Illustrative Constraint (6.a)

$$Eval ( P ) = ( \underline{Ind} ( \underline{Enc} ( P ) ) = \underline{S} )$$

Then, at act 815, a Boolean satisfiability solver may be used to select Ind, Enc, and/or S subject to a conjunction of one or more instances of the illustrative constraints (6.a) (e.g., a conjunction over all P in a certain set of input patterns).

However, it should be appreciated that aspects of the present disclosure are not limited to using any particular constraint, or any constraint at all. For instance, as described above in connection with the example of FIG. 6B, the policy check function may be parametrized by a logical formula F, in addition to the indicator function Ind and the parameter S. Accordingly, in some embodiments, the following constraint may be provided at act 810 in the example of FIG. 8.

```
Illustrative Constraint (6.b)
Eval (P) = F (
            (Ind₀ (bit_lane_0 (Enc (P) ) ) = S₀),
            ...,
            (Ind_{N-1} (bit_lane_N−1 (Enc (P) ) ) = S_{N-1})
            )
```

Then, at act 815, a Boolean satisfiability solver may be used to select Ind, Enc, S, and/or F subject to a conjunction of one or more instances of the illustrative constraints (6.b) (e.g., a conjunction over all P in a certain set of input patterns).

In some embodiments, a type Labels may be provided in an input language of a Boolean satisfiability solver. As an example, Labels may be provided in a recursive manner based on one or more metadata type declarations in a policy language. For instance, Labels may include the empty metadata label { }. Additionally, or alternatively, for every metadata symbol A declared in the policy language, Labels may include a metadata label {A}.

Additionally, or alternatively, for every sum type T declared in the policy language, Labels may not include any metadata label having more than one of the metadata symbols in the sum type T.

Additionally, or alternatively, given domains D₁ and D₂ declared in the policy language, Labels may not include any metadata label having both a metadata symbol from D₁ and a metadata symbol from D₂.

Additionally, or alternatively, given a set W₁ of metadata labels for a first policy and a set W₂ of metadata labels for a second policy, Labels may include all metadata labels of the form L₁∩L₂, where L₁ is from X₁, L₂ is from X₂, and U denotes set union.

In some embodiments, Labels may only include metadata labels that are either obtained from an initialization specification, or resulting from a rule. For instance, referring to the example of FIG. 3, an initialization specification may associate a program counter with {NS_Red, EW_Red}. Additionally, or alternatively, each rule in the illustrative signalSafety policy, when triggered, may cause a metadata update for the program counter ({NS_Green, EW_Red}, {NS_Red, EW_Green}, et.).

In some embodiments, an evaluation function Eval: Labels^{M}→}0,1} may be provided in an input language of a Boolean satisfiability solver. For instance, the function Eval may be provided based on one or more policies written in a policy language. As an example, a first policy may have a corresponding evaluation function Eval₁:Labels^{M}->{0,1}, and a second policy may have a corresponding evaluation function Eval₂:Labels^{M}->{0,1}. A combined evaluation function Eval may be provided as follows.

$$Eval ( P ) = {Eval}_{1} ( P ) and {Eval}_{2} ( P )$$

As another example, a policy may include one or more policy rules R₀, R₁, . . . Each policy rule R may be translated into a corresponding evaluation function Eval_{R}, and a combined evaluation function Eval may be provided as follows.

$$Eval ( P ) = {Eval}_{R \_ 0} ( P ) or {Eval}_{R \_ 1} ( P ) or …$$

A policy rule R may be translated into an evaluation function Eval_{R} in any suitable manner. For instance, referring to the example of FIG. 3, the illustrative signalSafety policy may have the following rule.

rule_1 (code == [+GoGreenNS], env == [NS_Red, EW_Red] −>
env = {NS_Green, EW_Red} )

Given P=<L₀, L₁>, an evaluation function for rule_1 may map P to 1 if L₀ includes at least the metadata symbol GoGreenNS, and L₁ includes at least the metadata symbols NS_Red and EW_Red.

Additionally, or alternatively, the illustrative signaiSafety policy may have the following rule.

```
rule_self (code == [−GoGreenNS, −GoGreenEW,
                  −GoYellowNS, −GoYellowEW,
                  −GoRedNS, −GoRedEW], env == _ −>
        env = env)
```

Given P=<L₀, L₁>, an evaluation function for rule_self may map P to 1 if L₀ does not include any of the metadata symbols GoGreenNS, GoGreenEW, GoYellowNS, GoYellowEW, GoRedNS, and GoRedEW. The metadata label L₁ may not be taken into account.

It should be appreciated that aspects of the present disclosure are not limited to any particular rule construct or interpretation thereof. For instance, in some embodiments, a rule may include a list of one or more metadata symbols enclosed in braces (as opposed to brackets). An evaluation function may interpret such a list to require that a metadata label consist of exactly the enclosed metadata symbol(s).

Returning to the example of FIG. 8, a Boolean satisfiability solver may be used, at act 815, to select Ind, Enc, and/or S subject to a conjunction of one or more constraints of the following form.

$$Eval ( P ) = ( \underline{Ind} ( \underline{Enc} ( P ) ) = \underline{S} )$$

In some embodiments, the conjunction of one or more constraints may be taken over all P in Labels^{M}. However, the inventors have recognized and appreciated that Labels^{M} may be a large set. As such, if the above constraint is to be satisfied for all P in Labels^{M}, the Boolean satisfiability solver may be less likely to find a solution, or it may take more processor cycles (e.g., more processor cores and/or more time) to do so.

Accordingly, in some embodiments, the conjunction of one or more constraints may be taken over all P in a subset of Labels^{M} (as opposed to Labels^{M} in its entirety). For instance, the inventors have recognized and appreciated that a significant number of metadata labels in Labels may not actually appear in any allowed input pattern. Accordingly, in some embodiments, a subset Labels′ of Labels may be provided that includes metadata labels appearing in one or more allowed input patterns, such as those identified at act 805 in the example of FIG. 8. The conjunction of one or more constraints may then be taken over all P in Labels M.

In some embodiments, an indicator function Ind: ({0, 1}^{M})^{N}>1{0, 1}^{V} may be provided in an input language of a Boolean satisfiability solver. As an example, the indicator function Ind may be provided as <Ind₀, . . . , Ind_{N-1}>, where each Indⱼ is provided based on the following equation:

$${{Ind}_{j} ( X )}^{T} = {H}_{j} {X}^{T}$$

In some embodiments, Hⱼ may be a variable for some bit lane j, so that a solution found by the Boolean satisfiability solver may include a matrix Hⱼ to be used to implement an indicator function Indⱼ for the bit lane j.

In some embodiments, an encode function Enc: Labels^{M}->({0,1}^{N})^{M} may be provided in an input language of a Boolean satisfiability solver. As an example, the encode function Enc may be provided as <Enc₀, . . . , Enc_{M-1}>, where Encᵢ: Labels->{0, 1}^{N} may be a variable for some input slot i. Thus, a solution found by the Boolean satisfiability solver may include an encode function Encᵢ for the input slot i.

In some embodiments, a parameter S:({0, 1}^{V})^{N} may be provided in an input language of a Boolean satisfiability solver. As an example, the parameter S may be provided as <S₀, . . . , S_{M-1}>, where Sⱼ: {0, 1}^{V} may be a variable for some bit lane j. Thus, a solution found by the Boolean satisfiability solver may include a parameter Sⱼ for the bit lane j.

The inventors have recognized and appreciated that, given an allowed input pattern P (which is in Labels′^{M}, defined similarly as Labels′^{M}), Eval(P) may be 1 by construction of Eval. The corresponding constraint may provide that (Ind(Enc(P))=S)=Eval(P)=1. As a result, Ind(Enc(P)) may match S, and a policy check function parameterized by Ind and S may map Enc(P) to 1. Hence, the policy check function may have no false positive error.

Conversely, given a disallowed input pattern P in Labels′^{M}, Eval(P) may be 0 by construction of Eval. The corresponding constraint may provide that (Ind(Enc(P))=S)=Eval(P)=0. As a result, Ind(Enc(P)) may not match S, and a policy check function parameterized by Ind and S may map Enc(P) to 0. Hence, the policy check function may have no false negative error in Labels′^{M}.

Although the inventors have recognized and appreciated various advantages of using an evaluation function, aspects of the present disclosure are not so limited. In some embodiments, a constraint for an allowed input pattern P may simply provide that Ind(Enc(P))=S, as described above.

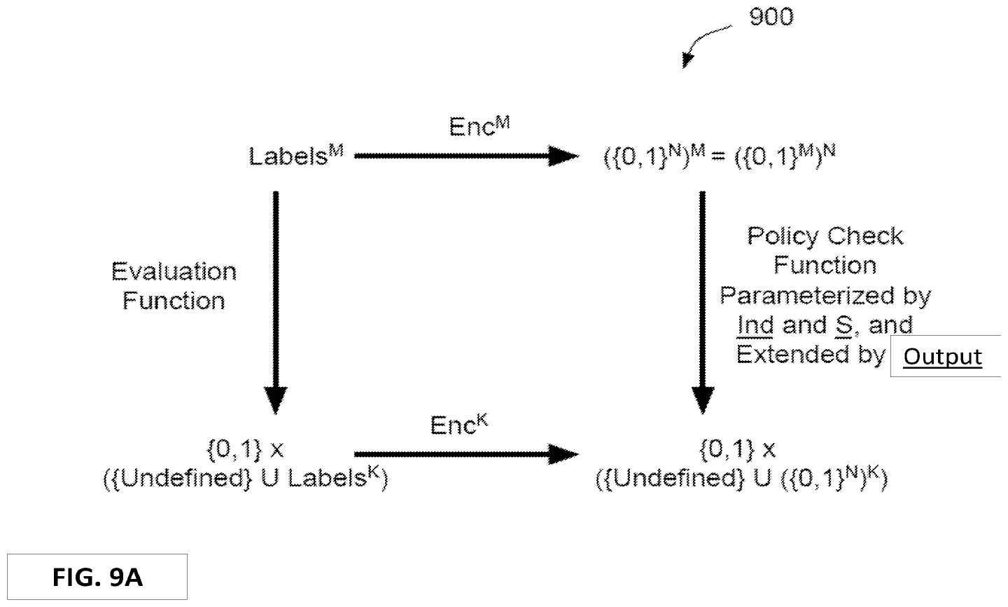

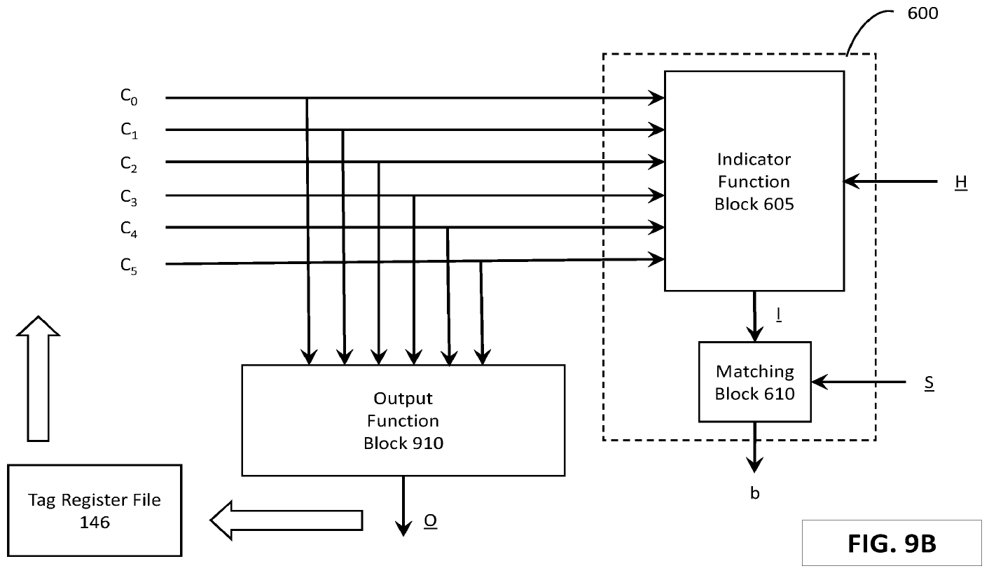

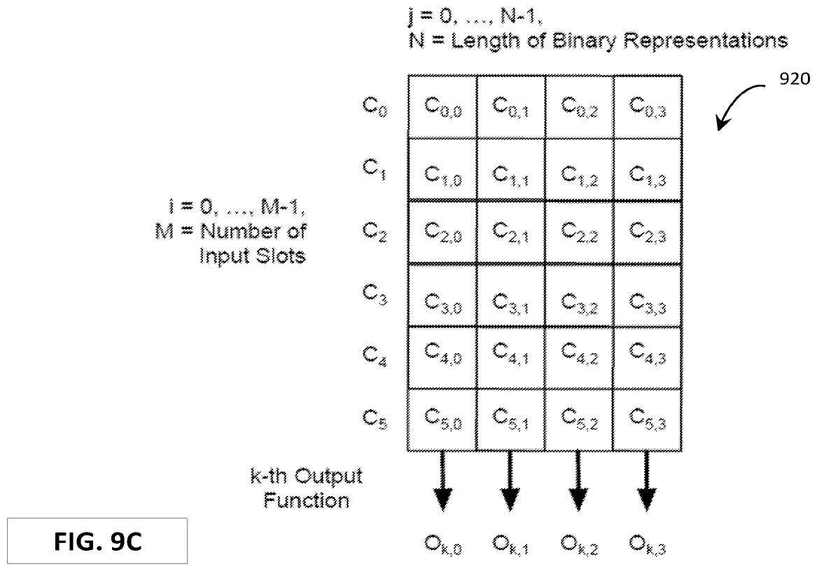

FIG. 9A shows an illustrative arrangement 900 of functions, in accordance with some embodiments. In this example, there are M input slots and K output slots. Accordingly, an input pattern may include up to M metadata labels, one for each input slot. A result may include one bit indicating whether an instruction giving rise to the input pattern is allowed. If the instruction is allowed, the result may also include an output pattern of up to K metadata labels, one for each output slot.

In some embodiments, the arrangement 900 may include an encode function Enc that maps input patterns to N-tuples of bit string(s) of length M. Thus, Enc may also be viewed as a function that maps input patterns to M-tuples of bit string(s) of length N. For instance, the encode function Enc may be Enc^{M} for some suitable Enc that maps metadata labels to bit strings of length N.

The inventors have recognized and appreciated that it may be desirable to extend a binary policy check function (e.g., as described in connection with the examples of FIGS. 6A-B, 7A-B, and 8) with an output function that maps an M-tuple of bit string(s) of length N (or an N-tuple of bit string(s) of length M) to a K-tuple of bit string(s) of length N, where each bit string in the K-tuple may encode an output metadata label.

In some embodiments, an output function may be a partial function. For instance, the output function may be undefined for all disallowed input patterns. Additionally, or alternatively, the output function may be undefined for one or more allowed input patterns (e.g., an input pattern corresponding to an allowed instruction without any metadata update).

In some embodiment, the illustrative evaluation function Eval described in connection with the example of FIG. 8 may be extended to output zero or more metadata labels. For instance, given an input pattern P=<L₀, . . . , L_{M-1}>, Eval(P) may include a pair of values. The first value may be a bit indicating whether an instruction giving rise to P is allowed. If the first value is 0 (indicating the instruction is disallowed), then the second value may be a default value, such as Undefined. If the first value is 1 (indicating the instruction is allowed), but there is no metadata update, then the second value may also be Undefined. On the other hand, if the first value is 1 (indicating the instruction is allowed), and there is at least one metadata update, then the second value may include an output pattern Q=<U₀, . . . , U_{K-1}>.

Referring to the example of FIG. 3, the illustrative signaiSafety policy may have the following rule.

rule_1 (code == [+GoGreenNS], env == [NS_Red, EW_Red] −>
env = {NS_Green, EW_Red} )

Given P=<L₀, L₁>, if the metadata symbol GoGreenNS is in L₀, and the metadata symbols NS_Red and EW_Red are in L₁, an evaluation function Eval (in an input language of a Boolean satisfiability solver) for rule_1 may map P to <1, L₂>, where L₂ is a result of replacing NS_Red with NS_Green in L₁. Otherwise, the evaluation function Eval may map P to <0, Undefined>.

Referring to the example of FIG. 8, a Boolean satisfiability solver may be used, at act 815, to select Ind, Enc, and/or S subject to a conjunction of one or more constraints of the following form.

(Proj₀ (Eval (P)) = (Ind (Enc^{M} (P)) =S)) and
(Enc^{K} (Proj₁ (Eval (P))) = Output (Enc^{M} (P)))

Here Proj₀ and Proj₁ denote projection functions for ordered pairs. For instance, if Eval(P)=<b,Q>, then Proj₀(Eval(P))=b and Proj₁ (Eval(P))=Q. Thus, the above constraint may also be written as follows.

Illustrative Constraint (7)

(Eval (P) = <b, Q>) and
(b = (Ind (Enc^{M} (P)) =S)) and
(Enc^{K} (Q) = Output (Enc^{M} (P)))

The inventors have recognized and appreciated that, in some instances, the above constraint may be restrictive, and it may be challenging to find a solution at act 815 in the example of FIG. 8.

The inventors have further recognized and appreciated that, because an output function may be undefined for all disallowed input patterns, the above constraint may be relaxed as follows.

Illustrative Constraint (8)

(Eval (P) = <b, Q>) and
(b = (Ind (Enc^{M} (P)) =S)) and
((not b) or (Enc^{K} (Q) = Output (Enc^{M} (P))))

This relaxed constraint does not require Enc^{K}(Q) to match Output (Enc^{M}(P)) if Ind (Enc^{M}(P)) does not match S. Thus, a solution may be found more readily, thereby improving performance and/or reducing resource consumption (e.g., power, memory, etc.).

It should also be appreciated that aspects of the present disclosure are not limited to using a Boolean satisfiability solver to select all of Ind, Enc, and S. Any one or more of these may be selected in another suitable manner. Additionally, or alternatively, one or more of the output functions Outputₖ (k=0, . . . , K−1) may treated as parameter(s), and a Boolean satisfiability solver may be used to select such an output function Outputₖ.

As described above, a Boolean satisfiability solver may, in some embodiments, search for a solution subject to a conjunction of constraints. For example, an individual constraint may be an instance of the illustrative constraint (7) or (8), and a conjunction may be taken over all P in Labels^{M} or a subset thereof (e.g., Labels M).

The inventors have recognized and appreciated that Labels^{M} (or, in some instances, even Labels′^{M}) may be a very large set. As such, a conjunction over all P in Labels^{M} (or Labels′^{M}) may be restrictive, and it may be challenging for a Boolean satisfiability solver to find a solution. Accordingly, in some embodiments, the conjunction of constraints may be taken over one or more allowed input patterns, such as those identified at act 805 in the example of FIG. 8. Since a set of allowed input pattern(s) may be much smaller than Labels^{M} (or Labels′^{M}), a solution may be found more readily at act 815 in the example of FIG. 8, thereby improving performance and/or reducing resource consumption (e.g., power, memory, etc.).

However, the inventors have recognized and appreciated that, if a conjunction is taken only over one or more allowed input patterns, one or more false negative errors may occur. Accordingly, in some embodiments, a solution found by a Boolean satisfiability solver may be validated to confirm whether there is any false negative error.

For instance, given a solution Ind, Enc, S, and Output, a set of encodings may be obtained by applying Enc to all labels in Labels. In some embodiments, the solution may have been found subject to an additional constraint that Enc is an injective function. Accordingly, there may be as many encodings of labels as there are labels in Labels.

Additionally, or alternatively, a pre-image of S under Ind may be identified. As described above, the pre-image of S under Ind may be a set of M-tuples <C₀, . . . , C_{M-1}> of bit string(s) of length N such that Ind (C₀, . . . , C_{M-1})=S, for some suitable M, N>=1.

The pre-image of S under Ind may be identified in any suitable manner. For instance, for each j=0, . . . , N−1, a pre-image of Sⱼ under Indⱼ may be identified. An element of the pre-image of S under Ind may be constructed as an array of bits similar to the illustrative array in the example of FIG. 6B, using a sequence of bit string(s)<X₀, . . . , X_{N-1}>, where each Xⱼ is from the preimage of Sⱼ under Indⱼ.

In some embodiments, the pre-image of S under Ind may be filtered to remove one or more M-tuples. For instance, given an M-tuple <C₀, . . . , C_{M-1}> in the pre-image, each Cᵢ(i=0, . . . , M−1) may be examined to determine if Cᵢ=Enc(L) for some L in Labels. If, for any i=0, . . . , M−1, there is no L in Labels such that Cᵢ=Enc(L), then the M-tuple <C₀, . . . , C_{M-1}> may be removed.

The inventors have recognized and appreciated that, if Enc is a one-to-one function, then so is Enc^{M}. Thus, there may be as many encodings of allowed input patterns as there are allowed input patterns. Accordingly, once all M-tuples in the pre-image have been examined and filtered, a count of remaining M-tuples may be obtained and compared against a count of all allowed input patterns (e.g., as determined at act 805 in the example of FIG. 8). If the count of remaining M-tuples is greater than the count of all allowed input patterns, then there may be a false negative error, and the solution may be invalidated. Otherwise, the solution may be accepted.

It should be appreciated that aspects of the present disclosure are not limited to validating a solution in any particular manner, or at all. In some embodiments, a solution may be validated by iterating over one or more input patterns in Labels^{M}. For instance, given an input pattern P, Enc^{M}(P) may be computed and checked against S. If Enc^{M}(P) does not match S, then P may be skipped.

If, on the other hand, Enc^{M}(P) matches S, then Eval(P) may be computed. If Eval(P)=1, then a next input pattern P′ may be checked. Otherwise, the solution may be invalidated. If all input patterns have been checked successfully, then the solution may be accepted.

The inventors have recognized and appreciated that it may be computationally intensive to check all input patterns in Labels^{M}. Accordingly, in some embodiments, one or more heuristics may be used to reduce a number of input patterns to be checked.

For instance, it may be known that certain labels may never be presented in certain input slot(s), or may only be presented in the input slot(s). With reference to the example of FIG. 3, the metadata type EW_T may be declared as follows, with the domain Data.

```
data (Data) EW_T<fixed> = EW_Red
  | EW_Yellow
  | EW_Green
```

Likewise, the metadata type Transition_T may be declared as follows, with the domain instruction.

```
data (Instruction) Transition_T<fixed> = GoGreenNS
  | GoGreenEW
  | GoRedNS
  | GoRedEW
  | GoYellowNS
  | GoYellowEW
```

In the illustrative signalSafety policy, the code input may be associated with the Instruction domain, whereas the env input may be associated with the Data domain. Thus, metadata symbols from the domain Data may never be presented in the code input slot, whereas metadata symbols from the domain instruction may never be presented in the env input slot.

Accordingly, if an input pattern P includes a metadata symbol from the domain Data in the code input slot, or a metadata symbol from the domain instruction in the env input slot, the input pattern P may be skipped.

In some embodiments, if a solution is invalidated, the Boolean satisfiability solver may be used to search for another solution. The new solution may be validated in a similar manner. This process may be repeated until a valid solution is found.

The inventors have recognized and appreciated that, if a binary policy check function and an output function are both readily computed in hardware, then an extended policy check function obtained therefrom may also be readily computed in hardware.

FIG. 9B shows an illustrative output function block 910, in accordance with some embodiments. In this example, the output function block 910 is configured to process input bit strings C₀, . . . , C₅ (which are also provided to the illustrative indicator function block 605 in the example of FIG. 6A). In some embodiments, the input bit strings C₀, . . . , C₅ may be output by the illustrative conversion block 750 in the example of FIG. 7B.

Thus, the output function block 910 may operate in parallel with the illustrative hardware block 600 in the example of FIG. 6A. Together, the hardware block 600 and the output function block 910 may implement an extended policy check function.

In some embodiments, the output function block 910 may process an M-tuple <C₀, C_{M-1}> of bit string(s) of length N, and may output a K-tuple <O₀, . . . , O_{K-1}> of bit string(s) of length N, for some suitable M, K>=1. An illustrative implementation of the output function block 910 is described below in connection with the example of FIG. 9C.

In some embodiments, the bit string(s) O₀, . . . , O_{K-1} may be stored in a register file, such as the illustrative tag register file 146 in the example of FIG. 1. Such a bit string Oₖ may be a binary representation of an output metadata label, which may subsequently be used as an input metadata label (e.g., to construct an input pattern for a subsequently executed instruction). Thus, the bit string Oₖ may be accessed from the tag register file 146, and may be provided to the indicator function block 605, the conversion block 750, and/or the output function block 910 as input.

FIG. 9C shows an illustrative array 920 of bits, in accordance with some embodiments. Like the illustrative array 650 in the example of FIG. 6B, the array 920 has M rows and N columns, where M is a number of input slots, and N is a length of binary representations. In this example, there are six input slots (i.e., M=6), and hence there are six rows. These rows may correspond, respectively, to bit strings C₀, . . . , C₅. Moreover, each bit string Cᵢ in this example is 4-bit long (i.e., N=4), and hence there are four columns.

In some embodiments, an output function Outputₖ (k=0, . . . , K−1) may be provided for each output slot k. The inventors have recognized and appreciated that, if each output function Outputₖ is readily computed in hardware, then a combined output function Output=<Output₀, . . . , Output_{K-1}> may also be readily computed in hardware. For instance, given K hardware blocks implementing, respectively, the output functions Output₀, . . . , Output_{K-1}, respectively (where K>1), the combined output function Output may be implemented simply by placing the K hardware blocks in parallel.

In some embodiments, an output function Outputₖ may compute, for each bit lane j in the array 920, an output bit O_{k,j}. Thus, the output function Outputₖ may map an M-tuple of bit string(s) of length N (i.e., C₀, . . . , C_{M-1}) to another bit string of length N. For instance, the output bit O_{k,j} may be computed by combining C_{0,j}, . . . , C_{M-1,j} with an exclusive OR (XOR) operator. Thus, the output bit O_{k,j} may be a parity bit for the bit string C_{0,j}: . . . : C_{M-1,j}.

It should be appreciated that aspects of the present disclosure are not limited to having multiple output slots. In some embodiments, K may be 1, so there may be only one output slot.

As discussed above, in some embodiments, if a binary policy check function maps an M-tuple of bit string(s) of length N to 0 (indicating that an instruction giving rise to the M-tuple is disallowed), an output function may map the M-tuple of bit string(s) of length N to Undefined. Thus, it may be desirable to compute the binary policy check function first. If the binary policy check function outputs 0, the output function may not be computed, which may lead to increased performance and/or reduced power consumption.

However, it should be appreciated that aspects of the present disclosure are not limited to computing a binary policy check function and an output function in any particular order. In some embodiments, an output function Output may be computed first, and a result of the output function Output may be used to look up a parameter S from a table stored in a selected memory (e.g., an on-chip RAM). The parameter S may then be compared against a result of an indictor function Ind to provide a result of the binary policy check function.

In this manner, different parameters S may be used for different output patterns, respectively. This may increase degrees of freedom, which may in turn increase a likelihood that a suitable solution may be found by a Boolean satisfiability solver. However, it should be appreciated that aspects of the present disclosure are not so limited.

The inventors have recognized and appreciated that, to reduce memory usage, it may be desirable to store binary representations of metadata labels in a compressed form (e.g., in the illustrative metadata memory 125 in the example of FIG. 1). However, the inventors have also recognized and appreciated that performing compression at run time may increase power consumption and/or decrease performance. Accordingly, in some embodiments, an output function may be used that outputs bit strings of length N′, for some N′<N.

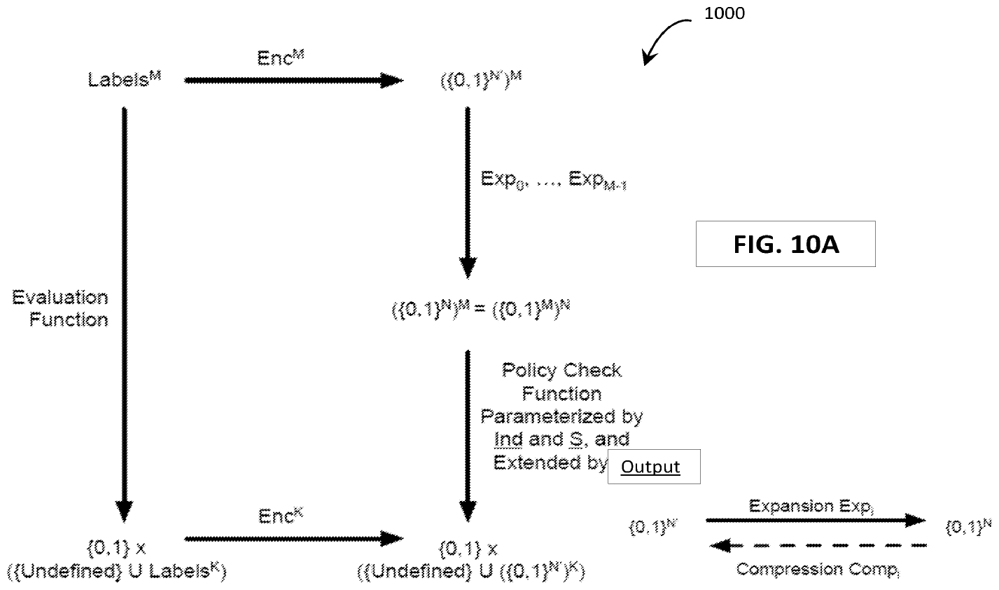

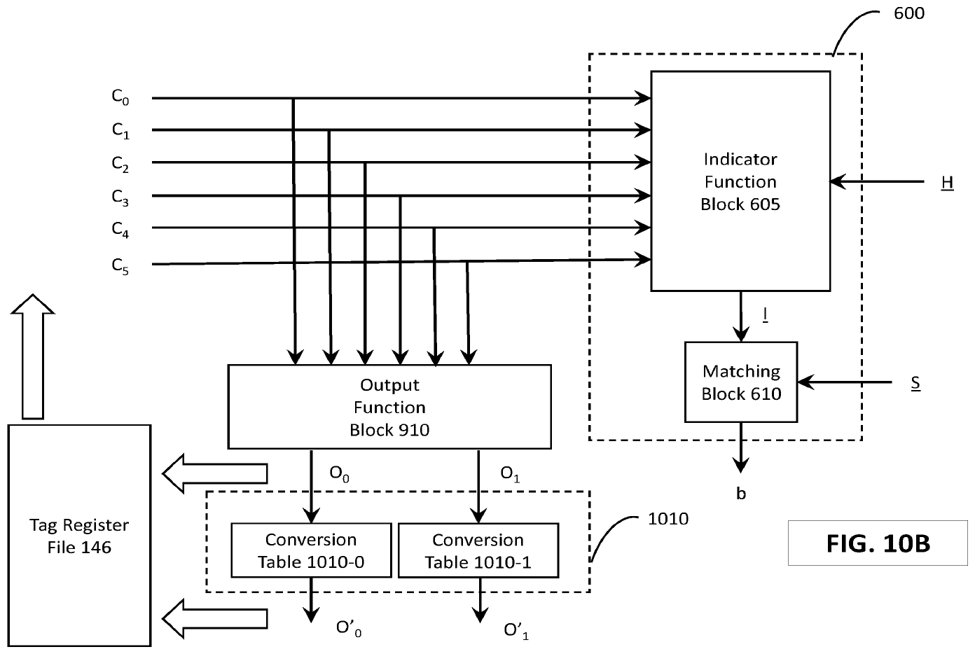

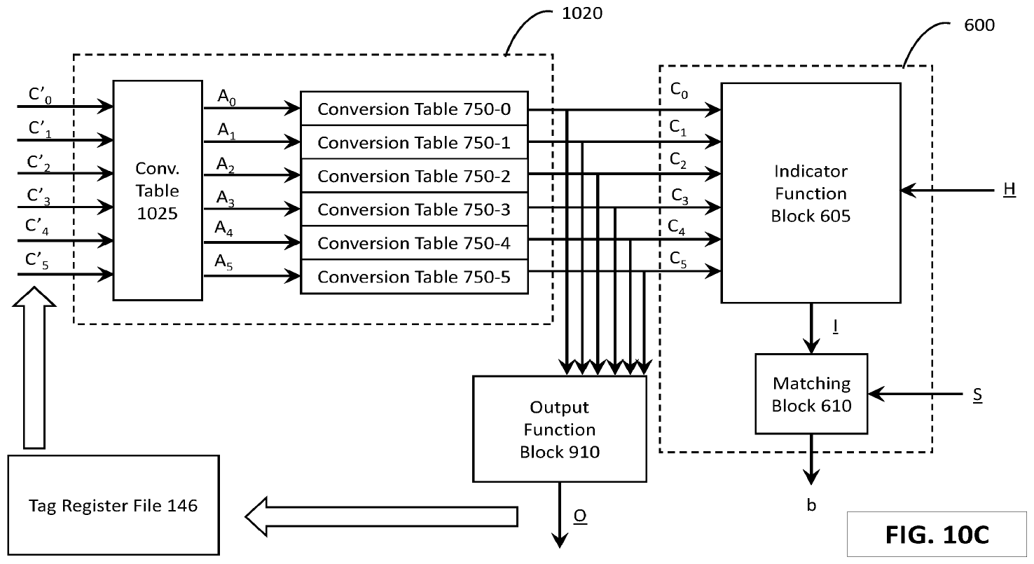

FIG. 10A shows an illustrative arrangement 1000 of functions, in accordance with some embodiments. In this example, an encode function Enc is provided as <Enc₀, . . . , Enc_{M-1}>, where each Encᵢ (i=0, . . . , M−1) may be Enc followed by Expᵢ, for some suitable encode function Enc and some suitable expansion function Expᵢ. For instance, each expansion function Expᵢ may be implemented by a conversion table that maps bit strings of length N′ to bit strings of length N, for some N′<N (e.g., as described in connection with the example of FIG. 7B).

In some embodiments, an output function Outputₖ may output a bit string of length N′, instead of length N. For instance, each bit string Cᵢ may be four bytes long (i.e., N=32), and there may be four output functions Outputₖ (k=0, . . . , 3), each outputting a bit string of length N′=8, instead of length N=32.

Such an output function Outputₖ may be implemented in any suitable manner. For instance, an output function Outputₖ may compute parity bit(s) for only a subset of bit lane(s). As an example, an output bit Oⱼ may be computed for each bit lane j by combining C_{0,j}, . . . , C_{M-1,j} with an exclusive OR (XOR) operator, and Output₀ may output O₀: . . . : O₇, Output₁ may output O₈: . . . : O₁₅, Output₂ may output O₁₆: . . . : O₂₃, and Output₃ may output O₂₄: . . . O₃₁. Thus, each output function Outputₖ may compute parity bits for one of the four bytes of Cᵢ (i=0, . . . , M−1).

It should be appreciated that aspects of the present disclosure are not limited to partitioning bit lanes in any particular manner, or at all. In some embodiments, two output functions may be based on, respectively, two overlapping sets of one or more bit lanes. Indeed, two output functions may be based on a common set of one or more bit lanes, but may manipulate such input bits differently to produce different output bits. Additionally, alternatively, two output functions may be based on, respectively, two sets having different numbers of bit lanes.

It should also be appreciated that aspects of the present disclosure are not limited to implementing output functions in any particular manner, or at all. In some embodiments, one or more of the output function(s) Outputₖ (k=0, . . . , K−1) may treated as parameter(s), and a Boolean satisfiability solver may be used to select such an output function Outputₖ.

Referring again to the example of FIG. 8, a Boolean satisfiability solver may be used, at act 815, to select Ind, Enc, S, and/or Output subject to a conjunction of one or more constraints of the following form.

(Proj₀ (Eval (P)) = (Ind (Exp (Enc^{M} (P))) =S)) and
(Enc^{K} (Proj₁ (Eval (P))) = Output (Exp (Enc^{M} (P))))

The above constraint may also be written as follows.

(Eval (P) = <b, Q>) and
(b = (Ind (Exp (Enc^{M} (P))) =S)) and
(Enc^{K} (Q) = Output (Exp (Enc^{M} (P))))

Here Exp denotes expansion function(s)<Exp₀, . . . , Exp_{M-1}>, for example, as described in connection with the example of FIG. 7B.

For reasons similar to those explained in connection with the example of FIG. 9A, the above constraint may be relaxed as follows.

(Eval (P) = <b, Q>) and
(b = (Ind (Exp (Enc^{M} (P))) =S)) and
((not b) or (Enc^{K} (Q) = Output (Exp (Enc^{M} (P)))))

However, it should be appreciated that aspects of the present disclosure are not limited to using any particular relaxed constraint, or any relaxed constraint at all.

As described above in connection with the example of FIG. 9A, a conjunction of constraints may, in some embodiments, be taken over one or more allowed input patterns, and a resulting solution may be validated to confirm whether there is any false negative error.

It should be appreciated that aspects of the present disclosure are not limited to using a Boolean satisfiability solver to select all of Ind, Enc, S, and Output. Any one or more of these may be selected in another suitable manner. Additionally, or alternatively, one or more of the expansion function(s) Expᵢ (i=0, . . . , M−1) may be treated as parameter(s). For instance, for some i=0, . . . , M−1, the expansion function Expᵢ may be provided as a variable in an input language of a Boolean satisfiability solver, so that a solution found by the Boolean satisfiability solver may include a solution for Expᵢ.

It should also be appreciated that aspects of the present disclosure are not limited to using an expansion function Expᵢ for every input slot i, or for any input slot i. The inventors have recognized and appreciated that, for some input slot i and/or corresponding output slot k (e.g., env in the illustrative signaiSafety policy in the example of FIG. 3), binary representations of metadata labels may remain in a register (e.g., in the illustrative tag register file 146 in the example of FIG. 1), without ever being written to any memory. Thus, in some embodiments, for such an input slot i and/or corresponding output slot k, an encode function may be used that maps metadata labels to binary representations of length N, as opposed to length N′.

As described in connection with the example of FIG. 3, an input slot may be associated with one or more domains declared in a policy language. For instance, with reference to the illustrative signaiSafety policy, the code input may be associated with the Instruction domain, whereas the env input may be associated with the Data domain. Accordingly, in some embodiments, if uncompressed binary representations (e.g., length N) are to be used for an input slot i, and the input slot i is the only input slot associated with one or more domains, then an encode function that maps metadata labels to binary representations of length N may be used for all metadata labels in the one or more domains.

The inventors have recognized and appreciated that, in some instances, multiple allowed input patterns may be mapped to a common output pattern. Thus, a number of possible allowed input patterns may be greater than a number of possible output patterns. For instance, referring again to the illustrative signalsafety policy in the example of FIG. 3, the following rules may have a common output pattern.

```
rule_5 (code == [+GoRedNS], env == [NS_Yellow, EW_Red] ->
  env = {NS_Red, EW_Red})
rule_6 (code == [+GoRedEW], env == [NS_Red, EW_Yellow] ->
  env = {NS_Red, EW_Red})
```

The inventors have further recognized and appreciated that if two different input patterns P₀ and P₁ are similar (e.g., differing only by one metadata label), a Boolean satisfiability solver may, in some instances, be unable to find a solution for an evaluation function Eval such that Eval(P₀)=Eval(P₁).

Accordingly, in some embodiments, a conversion block may be provided to convert bit strings of length N for one or more output slots k, k=0, . . . , K. This may increase degrees of freedom, which may in turn increase a likelihood that a suitable solution may be found by a Boolean satisfiability solver. However, it should be appreciated that aspects of the present disclosure are not so limited.

FIG. 10B shows an illustrative conversion block 1010, in accordance with some embodiments. For instance, the conversion block 1010 may be used to convert a K-tuple <O₀, . . . , O_{K-1}> of bit string(s) of length N to a K-tuple <O′₀, . . . , O′_{K-1}> of bit string(s) of length N′, for some suitable K, N, N′>=1.

In some embodiments, N′ may be strictly less than N, so that the conversion block may be a compression block. For instance, the compressed bit strings O′₀, . . . , O′_{K-1} may be stored in a metadata memory (e.g., the illustrative metadata memory 125 in the example of FIG. 1), which may reduce memory usage. However, it should be appreciated that aspects of the present disclosure are not so limited. In some embodiments, N′ may be strictly greater than, or equal to, N.

In the example of FIG. 10B, the K-tuple <O₀, . . . , O_{K-1}> is output by the illustrative output function block 910 in the example of FIG. 9B. The output function block 910 may receive an input pattern <C₀, . . . , C_{M-1}> for some suitable M>=1, where each input bit string may be of length N.

In some embodiments, the conversion block 1010 may include a conversion table 1010-k for each k=0, . . . , K−1. Such a conversion table may be similarly implemented as the illustrative conversion table(s) 750-i (i=0, . . . , M−1) in the example of FIG. 7B.

Referring again to the example of FIG. 8, a Boolean satisfiability solver may be used, at act 815, to select Ind, Enc, S, Exp, and/or O subject to a conjunction of one or more constraints of the following form.

(Proj₀ (Eval (P)) = (Ind (Exp (Enc^{M} (P))) =S)) and
(Enc^{K} (Proj₁ (Eval (P))) = Com (Output (Exp (Enc^{M} (P)))))

This constraint may also be written as follows.

(Eval (P) = <b, Q>) and
(b = (Ind (Exp (Enc^{M} (P))) =S)) and
(Enc^{K} (Q) = Com (Output (Exp (Enc^{M} (P)))))

Here Exp denotes expansion function(s)<Exp₀, . . . , Exp_{M-1}>, for example, as described above in connection with the example of FIG. 7B, whereas Com denotes compression function(s)<Com₀, . . . , Com_{K-1}> that each map bit strings of length N to bit strings of length N′.

For reasons similar to those explained in connection with the example of FIG. 9A, the above constraint may be relaxed as follows.

(Eval (P) = <b, Q>) and
(b = (Ind (Exp (Enc^{M} (P))) =S)) and
((not b) or (Enc^{K} (Q) = Com (Output (Exp (Enc^{M} (P))))))

However, it should be appreciated that aspects of the present disclosure are not limited to using any particular relaxed constraint, or any relaxed constraint at all.

As described above in connection with the example of FIG. 9A, a conjunction of constraints may, in some embodiments, be taken over one or more allowed input patterns, and a resulting solution may be validated to confirm whether there is any false negative error.

It should be appreciated that aspects of the present disclosure are not limited to using a Boolean satisfiability solver to select all of Ind, Enc, S, Output, and Exp. Any one or more of these may be selected in another suitable manner. Additionally, or alternatively, one or more of the compression function(s) Comₖ (k=0, . . . , K−1) may be treated as parameter(s). For instance, for some k=0, . . . , K−1, the compression function Comₖ may be provided as a variable in an input language of a Boolean satisfiability solver, so that a solution found by the Boolean satisfiability solver may include a solution for Comₖ. Such a solution may then be implemented by the conversion block 1010.

It should also be appreciated that aspects of the present disclosure are not limited to implementing a conversion table in any particular manner, or at all. For instance, for some input slot i and/or corresponding output slot k (e.g., env in the illustrative signalsafety policy in the example of FIG. 3), binary representations of metadata labels may remain in a register (e.g., in the illustrative tag register file 146 in the example of FIG. 1), without ever being written to any memory. Thus, in some embodiments, for such an input slot i and/or corresponding output slot k, an encode function may be used that maps metadata labels to binary representations of length N, as opposed to length N′. As such, no compression block may be used following the output function block 910.

FIG. 10C shows an illustrative conversion block 1020, in accordance with some embodiments. For instance, the conversion block 1020 may be similar to the illustrative conversion block 750 in the example of FIG. 7B, except the conversion table(s) 750-i (i=0, . . . , M−1, M>=1) may be preceded by another conversion table 1025. Additionally, or alternatively, the M-tuple <C₀, . . . , C_{M-1}> output by the conversion block 1025 may be provided to the illustrative output function block 910 in the example of FIG. 9B.

In some embodiments, the conversion table 1025 may be configured to convert an M-tuple <C′₀, . . . , C′_{M-1}> of bit string(s) of length N to an M-tuple <A₀, . . . , A_{M-1}> of bit string(s) of length N′, for some suitable N, N′>=1. Such a conversion table may be similarly implemented as the conversion table(s) 750-i (i=0, . . . , M−1).

In some embodiments, N′ may be strictly less than N, so that the conversion table 1010 may be a compression table. However, it should be appreciated that aspects of the present disclosure are not so limited. In some embodiments, N′ may be strictly greater than, or equal to, N.

Referring again to the example of FIG. 8, a Boolean satisfiability solver may be used, at act 815, to select Ind, Enc, S, Exp, and/or Output subject to a conjunction of one or more constraints of the following form.

(Proj₀ (Eval (P)) = (Ind (Exp (Com (Enc^{M} (P)))) =S)) and
(Enc^{K} (Proj₁ (Eval (P))) = Output (Exp (Enc^{M} (P))))
This constraint may also be written as follows.
(Eval (P) = <b, Q>) and
(b = (Ind (Exp (Com (Enc^{M} (P)))) =S)) and
(Enc^{K} (Q) = Output (Exp (Enc^{M} (P))))

Here Exp denotes expansion function(s)<Exp₀, . . . , Exp_{M-1}>, for example, as described above in connection with the example of FIG. 7B, whereas Com denotes a compression function that each map bit strings of length N to bit strings of length N′.

For reasons similar to those explained in connection with the example of FIG. 9A, the above constraint may be relaxed as follows.

(Eval (P) = <b, Q>) and
(b = (Ind (Exp (Com (Enc^{M} (P)))) =S)) and
((not b) or (Enc^{K} (Q) = Output (Exp (Enc^{M} (P)))))

However, it should be appreciated that aspects of the present disclosure are not limited to using any particular relaxed constraint, or any relaxed constraint at all.

As described above in connection with the example of FIG. 9A, a conjunction of constraints may, in some embodiments, be taken over one or more allowed input patterns, and a resulting solution may be validated to confirm whether there is any false negative error.

It should be appreciated that aspects of the present disclosure are not limited to using a Boolean satisfiability solver to select all of Ind, Enc, S, Output, and Exp. Any one or more of these may be selected in another suitable manner. Additionally, or alternatively, the compression function Com may be treated as a parameter. For instance, the compression function Com may be provided as a variable in an input language of a Boolean satisfiability solver, so that a solution found by the Boolean satisfiability solver may include a solution for Com. Such a solution may then be implemented by the conversion table 1025.

The inventors have recognized and appreciated that degrees of freedom may be increased by inserting a compression function (e.g., the conversion table 1025) followed by an expansion function (e.g., one of the conversion table(s) 750-i, i=0, . . . , M−1) into a data path of metadata labels. This may in turn increase a likelihood that a suitable solution may be found by a Boolean satisfiability solver.

For instance, two different bit strings O and O′ of length N may be mapped by the conversion table 1025 to a common bit string A of length N′. This may allow the output function block 910 to use O and O′ as different binary representations of a common metadata label.

However, it should be appreciated that aspects of the present disclosure are not limited to using any particular conversion block, or any conversion block at all.

The inventors have recognized and appreciated that, in some instances, a common allowed input pattern may correspond to different output patterns. For example, if an instruction giving rise to the input pattern is of a first type (e.g., arithmetic operation), the input pattern may be mapped to a first output pattern. By contrast, if an instruction giving rise to the input pattern is of a second type (e.g., load) different from the first type, the input pattern may be mapped to a second output pattern different from the first output pattern.

Accordingly, in some embodiments, there may be different output functions for different instruction types, respectively. A set of one or more constraints similar to those described above may be provided for each instruction type, and a solution returned by a Boolean satisfiability solver may satisfy all such constraints. At run time, instruction type information may be used to select a hardware component implementing an appropriate output function.

Additionally, or alternatively, each output function Output′ associated with a given instruction type may be obtained as a common output function Output followed by a suitable operation (e.g., XOR) that applies one or more selected salt values associated with the instruction type. Thus, at run time, instruction type information may be used to select one or more salt values to be applied to a result of the common output function.

However, it should be appreciated that aspects of the present disclosure are not limited to having different output functions for different instruction types. In some embodiments, an input slot may be provided for presenting a metadata label indicative of an instruction type. For instance, with reference to the example of FIG. 7B, an encoding of a metadata label indicative of an instruction type may be presented as input Aᵢ for some i=0, . . . , M−1. In this manner, given input patterns P and P′ that differ only at the i-th input, P and P′ may be mapped to different output patterns.

Illustrative code for the signalsafety policy in the example of FIG. 3 is provided below.

```
  module traffic_example.traffic:
  /*
    * Traffic light safety protocol
    */
  import:
          coreguard.riscv
  metadata:
        // Metadata to represent light states
  data (Data) NS_T<fixed> = NS_Red
              | NS_Yellow
              | NS_Green
  data (Data) EW_T<fixed> = EW_Red
              | EW_Yellow
              | EW_Green
        // Metadata to label code functions
  data (Instruction) Transition_T<fixed> = GoGreenNS
                  | GoGreenEW
                  | GoRedNS
                  | GoRedEW
                  | GoYellowNS
                  | GoYellowEW
        // Field declarations
  field env : Data
  field code : Instruction
  policy:
      signalSafety = transitions & isaExclusions
      transitions =
          rule_1 (code == [+GoGreenNS], env == [NS_Red, EW_Red] -> env
= {NS_Green, EW_Red})
      \hat{ } rule_2 (code == [+GoGreenEW], env == [NS_Red, EW_Red] -> env
= {NS_Red, EW_Green})
      \hat{ } rule_3 (code == [+GoYellowNS], env == [NS_Green, EW_Red] -> env
= {NS_Yellow, EW_Red})
      \hat{ } rule_4 (code == [+GoYellowEW], env == [NS_Red, EW_Green] -> env
= {NS_Red, EW_Yellow})
      \hat{ } rule_5 (code == [+GoRedNS], env == [NS_Yellow, EW_Red] -> env
= {NS_Red, EW_Red})
      \hat{ } rule_6 (code == [+GoRedEW], env == [NS_Red, EW_Yellow] -> env
= {NS_Red, EW_Red})
      \hat{ } rule_self(code == [−GoGreenNS, −GoGreenEW,
                −GoYellowNS, −GoYellowEW,
                −GoRedNS, −GoRedEW],
            env == _ -> env = env)
      \hat{ } rule_8 (code == [+GoGreenNS], env == [+EW_Green]
->
            fail “Safety Violation - East-West Lights Still Green”)
      \hat{ } rule_9 (code == [+GoGreenNS], env == [+EW_Yellow]
->
            fail “Safety Violation - East-West Lights Still
Yellow”)
      \hat{ } rule_10 (code == [+GoYellowNS], env == [+EW_Green]
->
            fail “Safety Violation - East-West Lights Still Green”)
      \hat{ } rule_11 (code == [+GoYellowNS], env == [+EW_Yellow]
->
            fail “Safety Violation - East-West Lights Still
Yellow”)
      \hat{ } rule_12 (code == [+GoGreenEW], env == [+NS_Green]
->
            fail “Safety Violation - North-South Lights Still
Green”)
      \hat{ } rule_13 (code == [+GoGreenEW], env == [+NS_Yellow]
->
            fail “Safety Violation - North-South Lights Still
Yellow”)
      \hat{ } rule_14 (code == [+GoYellowEW], env == [+NS_Green]
->
            fail “Safety Violation - North-South Lights Still
Green”)
      \hat{ } rule_15 (code == [+GoYellowEW], env == [+NS_Yellow]
->
            fail “Safety Violation - North-South Lights Still
Yellow”)
      \hat{ } rule_16 (code == _ , env == [NS_Yellow, EW_Green] -
>
            fail “Safety Violation - Neither Set of Lights Is Red”)
      \hat{ } rule_17 (code == _ , env == [NS_Green, EW_Yellow] -
>
            fail “Safety Violation - Neither Set of Lights Is Red”)
      \hat{ } rule_18 (code == _ , env == [NS_Green, EW_Green] -
>
            fail “Safety Violation - Neither Set of Lights Is Red”)
      \hat{ } rule_19 (code == _ , env == [NS_Yellow, EW_Yellow] -
>
            fail “Safety Violation - Neither Set of Lights Is Red”)
  require:
      init application.code.function.go_green_EW
{GoGreenEW}:(code)
      init application.code.function.go_green_NS
{GoGreenNS}:(code)
      init application.code.function.go_yellow_EW
{GoYellowEW}:(code)
      init application.code.function.go_yellow_NS
{GoYellowNS}:(code)
```

| | |
|---|---|
| init application.code.function.go_red_EW | {GoRedEW}:(code) |
| init application.code.function.go_red_NS | {GoRedNS}:(code) |
| init ISA.RISCV.env | {NS_Red, |

EW_Red}:(env)

Illustrative configurations of various aspects of the present disclosure are provided below.

1. A method implemented by tag processing hardware, the method comprising acts of: receiving information relating to one or more instructions executed by a host system; using the information relating to the one or more instructions to construct an input pattern; processing, in hardware, the input pattern to obtain at least one indicator; determining whether the at least one indicator matches at least one parameter, wherein the at least one parameter is selected based on one or more policies being enforced by the tag processing hardware; and in response to determining that the at least one indicator does not match the at least one parameter, sending a signal to the host system to indicate a violation of the one or more policies.

2. The method of configuration 1, wherein: the input pattern comprises M input slots, where M>=1; for each i=0, . . . , M−1: the i-th input slot comprises a binary representation Cᵢ of a metadata label Lᵢ; and the binary representation Cᵢ comprises a bit string of length N, where N>=1.

3. The method of configuration 2, wherein: the at least one indicator comprises an indicator computed based at least in part on C_{0,j}, . . . , C_{M-1,j} for some j=0, . . . , N−1.

4. The method of configuration 3, wherein: the hardware circuitry is configured to multiply an V×M matrix H with a result of transposing <C_{0,j}, . . . , C_{M-1,j}>, where V>=1.

5. The method of configuration 4, wherein: the matrix H is selected based on the one or more policies being enforced by the tag processing hardware.

6. The method of configuration 1, further comprising an act of: processing, via the hardware circuitry, the input pattern to obtain an output pattern.

7. The method of configuration 6, wherein: the input pattern comprises M input slots, where M>=1; for each i=0, . . . , M−1: the i-th input slot comprises a binary representation Cᵢ of a metadata label Lᵢ; and the binary representation Cᵢ comprises a bit string of length N, where N>=1; and the output pattern comprises K output slots, where K>=1; for each k=0, . . . , K−1: the k-th output slot comprises a binary representation Oₖ of a metadata label Uₖ; and the binary representation Oₖ comprises a bit string of length N′, where N′>=1.

8. The method of configuration 7, wherein: N′ is different from N.

9. The method of configuration 7, wherein: the hardware circuitry comprises an output function block configured to process the binary representation(s) C₀, . . . , C_{M-1} to obtain the binary representation(s) O₀, . . . , O_{K-1}; the hardware circuitry further comprises a conversion block configured to process binary representation(s) A₀, . . . , A_{M-1} to obtain the binary representation(s) C₀, . . . , C_{M-1}; and for each i=0, . . . , M−1: the binary representation Aᵢ comprises a bit string of length N′.

10. The method of configuration 9, wherein: the conversion block comprises first conversion table and second conversion table different from the first conversion table; the first conversion table is configured to map Aᵢ to Cᵢ for some i=0, . . . , M−1; and the second conversion table is configured to map Aᵢ, to Cᵢ‘ for some i’=0, . . . , M−1 that is different from i.

11. The method of configuration 10, wherein: the conversion block further comprises a third conversion table; and the third conversion table is configured to map C′ᵢ to Aᵢ for each i=0, . . . , M−1.

12. A computer-implemented method for encoding one or more policies to be enforced, the method comprising acts of: identifying one or more allowed input patterns for the one or more policies to be enforced; constructing, based on the one or more allowed input patterns, a plurality of constraints; and identifying one or more encode functions that satisfy the plurality of constraints, wherein each encode function maps metadata labels to bit strings.

13. The method of configuration 12, wherein: the act of identifying one or more allowed input patterns comprises identifying all allowed input patterns for the one or more policies to be enforced; and the plurality of constraints comprise one or more constraints constructed from each of the allowed input patterns.

14. The method of configuration 12, wherein: the act of identifying one or more encode functions comprises identifying an assignment of a plurality of Boolean variables to truth values; the plurality of Boolean variables comprise a sequence of N Boolean variables associated with a metadata label, where N>1; and the one or more encode functions comprise an encode function that maps the metadata label to a bit string of length N obtained by concatenating the truth values assigned to the sequence of N Boolean variables associated with the metadata label.

15. The method of configuration 12, wherein: the at least one encode function comprises a plurality of encode functions corresponding, respectively, to a plurality of input slots; and the method further comprises an act of: selecting an encode function to be applied to a metadata label appearing in an input pattern, wherein the encode function is selected based on an input slot in which the metadata label appears in the input pattern.

16. The method of configuration 12, wherein: the plurality of constraints comprises a constraint constructed from an input pattern P; and the constraint includes an encode function Enc that maps input patterns to sequences of bit strings.

17. The method of configuration 16, wherein: Enc includes at least one variable; the act of identifying one or more encode functions comprises solving for Enc subject to the plurality of constraints; and the one or more encode functions that map metadata labels to bit strings are obtained based on a solution for Enc.

18. The method of configuration 17, wherein: the constraint further includes an indicator function Ind and a parameter S; Ind and/or S include at least one variable; and the act of identifying one or more encode functions comprises solving for Ind and/or S, simultaneously with Enc, subject to the plurality of constraints.

19. The method of configuration 18, wherein: the constraint provides that Ind (Enc (P)) matches S.

20. The method of configuration 18, wherein: the constraint provides that Eval(P)=(Ind (Enc (P))=S), wherein: Eval is an evaluation function constructed based on the one or more policies being enforced.

21. The method of configuration 20, wherein: the input patter P is an allowed input pattern.

22. The method of configuration 20, wherein: the input patter P is a disallowed input pattern; and for each metadata label L appearing in P, L appears in at least one allowed input pattern.

23. The method of configuration 18, wherein: the constraint provides that Eval(P)=F((Ind₀ (bit_lane_0 (Enc (P)))=S₀), . . . , (Ind_{N-1} (bit_lane_N−1 (Enc (P)))=S_{N-1})), wherein: Eval is an evaluation function constructed based on the one or more policies being enforced; and F is a logical formula.

24. The method of configuration 18, wherein: Enc comprises Enc^{M}, wherein: Enc is an encode function that maps metadata labels to bit strings; and M>=1; and the constraint provides that (i) Eval(P)=<b,Q>, (ii) b=(Ind (Enc^{M} (P))=S), and Enc^{K}(Q)=Output (Enc^{M} (P)), wherein: Eval is an evaluation function constructed based on the one or more policies being enforced; and Output is an output function that maps encoded input patterns to encoded output patterns.

25. The method of configuration 24, wherein: Output includes at least one variable; and the act of identifying one or more encode functions comprises solving for Ind, S, and/or Output, simultaneously with Enc, subject to the plurality of constraints.

26. A system comprising processing hardware configured to perform the method of any of the preceding claims.

27. The system of configuration 26, wherein the processing hardware comprises one or more processors programmed by executable instructions to perform the method of any of the preceding claims.

28. The system of configuration 26, wherein the processing hardware comprises one or more FPGAs programmed by bitstreams to perform the method of any of the preceding claims.

29. The system of configuration 26, wherein the processing hardware comprises one or more logic circuits fabricated into semiconductors, wherein the one or more logic circuits are configured to perform the method of any of the preceding claims.

30. At least one computer-readable medium having stored thereon the executable instructions of configuration 27.

31. At least one computer-readable medium having stored thereon the bitstreams of configuration 28.

32. At least one computer-readable medium having stored thereon at least one netlist for the bitstreams of configuration 28 and/or the one or more logic circuits of configuration 29.

33. At least one computer-readable medium having stored thereon at least one hardware description that, when synthesized, produces the at least one netlist of configuration 32.

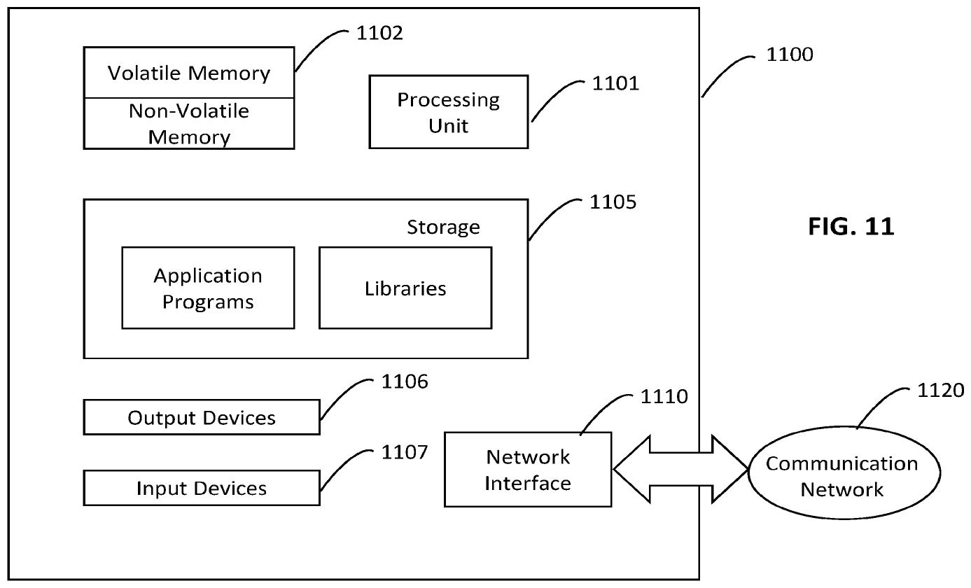

FIG. 11 shows, schematically, an illustrative computer 1100 on which any aspect of the present disclosure may be implemented. In the example shown in FIG. 11, the computer includes a processing unit 1101 having one or more processors and a computer-readable storage medium 1102 that may include, for example, volatile and/or non-volatile memory. The memory 1102 may store one or more instructions to program the processing unit 1101 to perform any of the functions described herein. The computer 1100 may also include other types of computer-readable medium, such as storage 1105 (e.g., one or more disk drives) in addition to the system memory 1102. The storage 1105 may store one or more application programs and/or resources used by application programs (e.g., software libraries), which may be loaded into the memory 1102.

The computer 1100 may have one or more input devices and/or output devices, such as output devices 1106 and input devices 1107 illustrated in FIG. 11. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1107 may include a microphone for capturing audio signals, and the output devices 1106 may include a display screen for visually rendering, and/or a speaker for audibly rendering, recognized text.

In the example of FIG. 11, the computer 1100 may also include one or more network interfaces (e.g., network interface 1110) to enable communication via various networks (e.g., communication network 1120). Examples of networks include local area networks (e.g., an enterprise network), wide area networks (e.g., the Internet), etc. Such networks may be based on any suitable technology, and may operate according to any suitable protocol. For instance, such networks may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer, or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in Field Programmable Gate Arrays or other semiconductor devices, or other tangible computer-readable media) encoded with one or more programs that, when executed on one or more processors, perform methods that implement the various embodiments of the present disclosure described above. The computer-readable medium or media may be transportable, such that the program or programs stored thereon may be loaded onto one or more different computers or other processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium that convey how the fields are related. However, any suitable mechanism may be used to relate information in fields of a data structure, including through the use of pointers, tags, or other mechanisms that how the data elements are related.

Various features and aspects of the present disclosure may be used alone, in any combination of two or more, or in a variety of arrangements not specifically discussed in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

1. A method implemented by tag processing hardware, the method comprising acts of:
receiving information relating to one or more instructions executed by a host system;
using the information relating to the one or more instructions to construct an input pattern;
processing, in hardware, the input pattern to obtain at least one indicator;
determining whether the at least one indicator matches at least one parameter, wherein the at least one parameter is selected based on one or more policies being enforced by the tag processing hardware; and
in response to determining that the at least one indicator does not match the at least one parameter, sending a signal to the host system to indicate a violation of the one or more policies.

2. The method of claim 1, wherein:
the input pattern comprises M input slots, where M>=1;
for each i=0, . . . , M−1:
the i-th input slot comprises a binary representation Cᵢ of a metadata label Lᵢ; and
the binary representation Cᵢ comprises a bit string of length N, where N>=1.

3. The method of claim 2, wherein:
the at least one indicator comprises an indicator computed based at least in part on C_{0,j}, . . . , C_{M-1,j} for some j=0, . . . , N−1.

4. The method of claim 3, wherein:
the hardware circuitry is configured to multiply an V×M matrix H with a result of transposing <C_{0,j}, . . . , C_{M-1,j}>, where V>=1.

5. The method of claim 4, wherein:
the matrix H is selected based on the one or more policies being enforced by the tag processing hardware.

6. The method of claim 1, further comprising an act of:
processing, via the hardware circuitry, the input pattern to obtain an output pattern.

7. The method of claim 6, wherein:
the input pattern comprises M input slots, where M>=1;
for each i=0, . . . , M−1:
the i-th input slot comprises a binary representation Cᵢ of a metadata label Lᵢ; and
the binary representation Cᵢ comprises a bit string of length N, where N>=1; and
the output pattern comprises K output slots, where K>=1;
for each k=0, . . . , K−1:
the k-th output slot comprises a binary representation Oₖ of a metadata label Uₖ; and
the binary representation Oₖ comprises a bit string of length N′, where N′>=1.

8. The method of claim 7, wherein:
N′ is different from N.

9. The method of claim 7, wherein:
the hardware circuitry comprises an output function block configured to process the binary representation(s) C₀, . . . , C_{M-1} to obtain the binary representation(s) O₀, . . . , O_{K-1};
the hardware circuitry further comprises a conversion block configured to process binary representation(s) A₀, . . . , A_{M-1} to obtain the binary representation(s) C₀, . . . , C_{M-1}; and
for each i=0, . . . , M−1:
the binary representation Aᵢ comprises a bit string of length N′.

10. The method of claim 9, wherein:
the conversion block comprises a first conversion table and a second conversion table different from the first conversion table;
the first conversion table is configured to map Aᵢ to Cᵢ for some i=0, . . . , M−1; and
the second conversion table is configured to map Aᵢ to Cᵢ for some i′=0, . . . , M−1 that is different from i.

11. The method of claim 10, wherein:
the conversion block further comprises a third conversion table; and
the third conversion table is configured to map C′ᵢ to Aᵢ for each i=0, . . . , M−1.

12.-25. (canceled)

26. A system comprising:
process hardware configured to:
receive information relating to one or more instructions executed by a host system;
use the information relating to the one or more instructions to construct an input pattern;
process, in hardware, the input pattern to obtain at least one indicator;
determine whether the at least one indicator matches at least one parameter, wherein the at least one parameter is selected based on one or more policies being enforced by the tag processing hardware; and
in response to determining that the at least one indicator does not match the at least one parameter, send a signal to the host system to indicate a violation of the one or more policies.

27. The system of claim 26, wherein the processing hardware comprises one or more processors programmed by executable instructions.

28. The system of claim 26, wherein the processing hardware comprises one or more FPGAs programmed by bitstreams.

29. The system of claim 26, wherein the processing hardware comprises one or more logic circuits fabricated into semiconductors.

30.-32. (canceled)

33. At least one computer-readable medium having stored thereon at least one hardware description that, when synthesized, produces at least one netlist for one or more logic circuits to be fabricated into semiconductors and/or bitstreams for programming one or more programmable logic devices, wherein the one or more logic circuits and/or the one or more programmed logic devices are configured to:
receive information relating to one or more instructions executed by a host system;
use the information relating to the one or more instructions to construct an input pattern;
process, in hardware, the input pattern to obtain at least one indicator;
determine whether the at least one indicator matches at least one parameter, wherein the at least one parameter is selected based on one or more policies being enforced by the tag processing hardware; and
in response to determining that the at least one indicator does not match the at least one parameter, send a signal to the host system to indicate a violation of the one or more policies.
